(19) United States
(12) Patent Application Publication
(10) Pub. No.: US 2006/0087698 A1
(43) Pub. Date: Apr. 27, 2006

(54) Systems and methods for variable trapping

(75) Inventor: David C. Allen, Denver, CO (US)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(73) Assignee: Quark, Inc., Denver, CO (US)

(21) Appl. No.: 11/253,820

(22) Filed: Oct. 18, 2005

Related U.S. Application Data
(63) Continuation-in-part of application No. 11/196,613, filed on Aug. 2, 2005.
Application No. 11/196,613 is a continuation-in-part of application No. 10/710,944, filed on Aug. 13, 2004.

(51) Int. Cl. H04N 1/409

(52) U.S. Cl. 358/3.26

(57) ABSTRACT

Various systems and methods for performing trapping in relation to one or more variable color objects are disclosed. As one example, a method is disclosed that includes identifying two or more objects with each of the objects being associated with a respective color. At least one of the associated colors is a variable color. The other color may be either variable or constant. A trap zone is defined in relation to the identified objects, and a transfer function is formed that defines a trap attribute for at least a portion of the trap zone. The trap attribute may be, but is not limited to, a trap direction and and/or ink in the trap zone. Such a trap direction may be, but is not limited to, a choke and a spread. Other examples are also disclosed.

### CROSS REFERENCE TO RELATED APPLICATIONS

The present application is a continuation in part of U.S. patent application Ser. No. 11/196,613 (Attorney Docket No. 56578-318840) entitled “Systems and Methods for Trapping in a Publishing Environment”, and filed Aug. 2, 2005 by Allen; which is a continuation in part of U.S. patent application Ser. No. 10/710,944 entitled “Automated Trapping System for Desktop Publishing”, and filed Aug. 13, 2004 by Allen. The aforementioned applications are assigned to an entity common hereto, and the entirety of the applications are incorporated herein by reference for all purposes.

Further, the present application is related to U.S. patent application Ser. No. ______ (Attorney Docket No. 56578-319547) entitled “Systems and Methods for Ink Selection in the Trapping Zone”, and filed on a date even herewith by Allen; U.S. patent application Ser. No. ______ (Attorney Docket No. 56578-319546) entitled “Systems and Methods for Recursive Trapping”, and filed on a date even herewith by Allen; and U.S. patent application Ser. No. ______ (Attorney Docket No. 56578-321784) entitled “Systems and Methods for Small Element Trapping”, and filed on a date even herewith by Allen. The aforementioned applications are assigned to an entity common hereto, and the entirety of the applications are incorporated herein by reference for all purposes.

### BACKGROUND OF THE INVENTION

The present invention is related to systems and methods for preparing media productions, and in particular to systems and methods for performing trapping between objects where one or more objects are painted with a variable color.

Electronic printing of multi-color pages typically involves printing on multiple separations to provide high quality publications. This process can involve four process colors (e.g., Cyan, Magenta, Yellow, Black) plus additional spot colors as needed (e.g., Red, Green, Blue). Applying each of the process colors involves an individual film separation or printing plate, and application of the spot colors involves an additional separation or printing plate for each additional color used.

Misregistration of the separations often causes a slight shift in the placement of the various colors. Because printing inks are often not completely opaque, printing one ink over another can result in a third color occuring at the intersection. This is desirable where the third color is intended, but undesirable where a crisp line between the colors is desired or where a smoother transition color is desired. Another problem occurs when a white space is left between printed inks. Compensating for the misregistrations is often referred to as trapping, and can involve the application of one or more rules to assure that neither white space nor unintended third colors are formed in the printing process. Typical trapping, however, is limited in its ability and often do not operate properly where a printed object utilizes unique colors having gray values and rich black values.

Hence, for at least the aforementioned reasons, there exists a need in the art for advanced systems and methods to address the needs of the industry.

### BRIEF SUMMARY OF THE INVENTION

The present invention is related to systems and methods for preparing media productions, and in particular to systems and methods for performing trapping between objects where one or more objects are painted with a variable color.

Some embodiments of the present invention provide methods for performing trapping where a variable color object is involved. The methods include identifying two or more objects that are each associated with a respective color. At least one of the associated colors is a variable color. The other color may be either variable or constant. In the methods, a trap zone is defined in relation to the identified objects, and a transfer function is formed that defines a trap attribute for at least a portion of the trap zone. The trap attribute may be, but is not limited to, a trap direction and/or an ink in the trap zone. Such a trap direction may be, but is not limited to, a choke and a spread.

In some cases, the method further comprises segmenting the trap zone into a plurality of portions. The portion of the trap zone associated with the transfer function may be one of the plurality of portions, and may include a substantially constant color region within the variable color. In some cases, multiple transfer functions are formed for different portions of the trap zone. In such cases, the multiple transfer functions may be aggregated to form an overall transfer function describing a larger portion of the trap zone. The overall transfer function may be, for example, a step function, a continuous function, or a discontinuous function.

Other embodiments of the present invention provide systems for performing trapping in a variable color environment. Such systems may include a computer capable of executing various instructions, and associated with a computer readable medium that includes the instructions. In some cases, the systems include a computer readable medium that includes instructions executable by a computer to receive an indication of a trap zone and form a transfer function that determines a trap attribute for a portion of the trap zone. In such cases, the trap zone may be associated with two objects with at least one of the objects exhibiting a variable color. In some cases, the instructions are further executable to identify the objects and associated colors. In various cases, the instructions are further executable to segment the trap zone into a plurality of portions. In such a case, the portion of the trap zone associated with the transfer function may be one of the plurality of portions that includes a substantially constant color region within the variable color. In some cases, the instructions are executable to form multiple transfer functions describing the various portions of the trap zone, and may further be executable to aggregate the multiple transfer functions into an overall transfer function. The overall transfer function may be, for example, a step function, a continuous function, or a discontinuous function.

Yet other embodiments of the present invention provide methods for performing trapping in relation to three or more objects. Such methods include receiving an identification of at least three objects and colors associated with the respective objects. In addition, an identification of a trap zone is received. The trap zone is associated with the aforementioned three objects. The methods further include performing a recursive trap where trap direction and/or a color for application into at least a portion of the trap zone is identified. The identified color is selected based upon one or more of the colors associated with the respective objects related to the trap zone. The trap direction may also be based on one or more of the colors associated with the respective objects.

In various instances of the aforementioned embodiments, performing the recursive trap further includes determining a trap color and a trap direction by evaluating the colors associated with two of the three objects. From this, an interim trap color is identified as well as a location of the trap between the two objects. In addition, another trap color and trap direction are determined based on the interim trap color and the color associated with the third of the three objects. This other trap color is used to paint a portion of the trap zone determined by the location of the trap between the first two objects and the colors of the third object and the interim color. In various cases, the trap direction is either a choke or a spread.

In other instances of the aforementioned embodiments, performing the recursive trap further includes determining a first trap direction based at least in part on the colors associated with two of the objects, and determining a second trap direction based at least in part on the first trap direction and the color associated with the other of the three objects. These trap directions may be, but are not limited to, a choke and a spread.

In some cases of the aforementioned embodiments, the recursive trapping is performed using a “bottom up” approach. Thus, for example, in the previous scenario, the third of the three objects may be a foreground object in relation to the other two objects. In a more specific case, the first of the three objects may be at least partially behind the other two objects, the second of the three objects may be partially sandwiched between the other two objects, and the third of the three objects is on top. Selection of the interim color and/or the color used to paint the finally determined trap zone may be done by determining one or more characteristics as more fully described herein. In some particular cases, color selection may be done by evaluating individual inks that compose the various colors. Based on the disclosure provided herein, one of ordinary skill in the art will recognize that an approach other than a bottom up approach may be utilized in accordance with one or more embodiments of the present invention. Further, based on the disclosure provided herein, one of ordinary skill in the art will recognize that a variety of color arbitration approaches may also be used in accordance with one or more embodiments of the present invention.

Other embodiments of the present invention provide systems for performing trapping in relation to three or more objects. Such systems may include a computer executing commands. In other cases, such systems may include a computer readable medium that includes instructions executable by a computer. In such cases, the instructions may be executable to receive identifications of three or more objects as well as colors associated with the respective objects. In addition, instructions are included that operate to receive an identification of a trap zone that is associated with the three objects, and to perform a recursive trap. During the recursive trap, a trap direction and/or a color is selected for application into at least a potion of the identified trap zone.

Yet other embodiments of the present invention provide methods for recursive trapping in a publishing environment. The methods include identifying a trap where the trap includes the intersection of at least three objects associated with respective colors. The methods further include determining a first ink characteristic associated with the color of the first one of the objects, determining a second ink characteristic associated with the color of the second one of the objects, and determining a third ink characteristic associated with the color of the third one of the objects. The first and second ink characteristics are compared, and based at least in part on the comparison, a controlling ink characteristic is determined. The controlling ink characteristic may be the first or the second ink characteristic. The method further includes comparing the third ink characteristic with the aforementioned controlling ink characteristic to determine a second controlling ink characteristic. The second controlling ink characteristic may be the third ink characteristic or the prior controlling ink characteristic. In some cases, the second controlling ink characteristic is used to determine a trap direction. This trap direction may be, but is not limited to, a spread or a choke.

In some instances of the aforementioned embodiments, a first of the objects is a foreground object in relation to a second of the objects. In such a case, determining the first ink characteristic associated with the color of the first object includes determining a luminance of the color associated with the first object based at least in part on the first ink. Determining the second ink characteristic associated with the color of the second object includes determining a luminance of the color of the second object based at least in part on the second ink. Comparing the first ink characteristic with the second ink characteristic includes comparing the luminance of the color of the first object with the luminance of the color of the second object. In such a case, the first controlling ink is associated with the color with greater luminance.

In the preceding instance, the third object may be a foreground color in relation to the first object. In such a case, determining the third ink characteristic associated with the color of the third object includes determining a luminance of the third color based at least in part on the third ink. Comparing the third ink characteristic with the first ink characteristic may include comparing the luminance of the third color with the luminance of the first color. In such a case, the second controlling ink is associated with the color of greater luminance. In some cases, determining the aforementioned ink characteristics may include performing two or more of the following operations in association with a particular color: evaluating a total luminance for the color based at least in part on a constituent ink used to form the color; evaluating a partial luminance for the color based at least in part on a constituent ink used to form the color; evaluating a total gray for the color based at least in part on a constituent ink used to form the color; evaluating a partial gray for the color based at least in part on a constituent ink used to form the color; and evaluating a principle gray for the first color based at least in part on a constituent ink used to form the color.

Yet further embodiments of the present invention provide methods for color arbitration in a trap zone. The methods include identifying two or more objects each associated with respective colors. In the methods, a trap zone is defined in relation to the objects, and an arbitration is performed between the colors associated with the objects. The arbitration results in the selection of a color that will be used in relation to the trap zone. In some cases, the color for the trap zone is distinct from either of the colors used in the arbitration. In various cases, the methods further include painting the selected color in at least a portion of the trap zone.

In some cases, a hue of the color of one of the objects is defined by first and second inks, and a hue of the color of the other object is defined by third and fourth inks. In some cases, the first ink is distinguished from the second ink by being different colors. Thus, for example, the first ink may be yellow while the third ink is magenta. In other cases, they are distinguished by being different percentages of the same color. Thus, for example, the first ink may be fifty percent magenta, while the third ink is twenty percent magenta. In yet other cases, the two compared inks may be identical. Based on the disclosure provided herein, one of ordinary skill in the art will recognize a variety of implementations of the first through fourth inks, and distinguishing factors thereof.

In one particular case, one of the objects is a foreground object and the other object is a background object. In such a case, arbitrating between the colors of the objects may include determining whether the luminance of the foreground object is greater than the luminance of the background object. Where it is determined that the luminance of the foreground object is greater than the luminance of the background object, an ink associated with the foreground object is included in the third color. Alternatively, where it is determined that the luminance of the foreground object is less than that of the background object, an ink associated with the background object is included in the third color.

In some cases, the methods further include determining a partial gray of the object colors. In such a case, the partial gray of, for example, the foreground object is associated with a fifth ink, and that of the background object is associated with a sixth ink. Where, for example, an ink associated with the foreground object is included in the third color, it may be determined whether the partial gray of the background object is greater than principle gray of the foreground object. Where it is determined that the partial gray of the background object is greater than the principle gray of the foreground object, the sixth ink is selected for inclusion in the third color. Alternatively, where it is determined that the partial gray of the foreground object is greater than the principle gray of the background object, the fifth ink is selected for inclusion in the third color.

In various cases, the luminance of the foreground object is compared with that of the background object. Where the luminance of the foreground object is greater than that of the background object, the first and second inks are selected for inclusion in the third color. However, where either the first or second ink is a zero ink, an ink from the background object corresponding to the zero ink is selected to replace the corresponding ink in the third color. Thus, as one particular example, where the first ink corresponds to the third ink and the first ink is zero percent magenta and the third ink is twenty percent magenta, the third ink would be selected to replace the first ink in the third color.

Yet other embodiments of the present invention provide systems for performing color arbitration in a trap zone. Such systems may include a computer associated with a computer readable medium that includes instructions executable by the computer. Other systems include just the computer readable medium with associated instructions executable by a computer. The instructions may be executable by the computer to receive an identification of two objects with each of the objects being associated with respective colors. In addition, the instructions are executable to arbitrate between the respective first and second colors of the objects to define a third color for use in a trap zone. In such cases, the trap zone may be associated with the identified objects.

Yet other embodiments of the present invention provide systems and methods for trapping in a publishing environment. For example, a method for trapping in a printing process is disclosed and includes identifying two or more objects associated with the trap. One of the objects is a foreground object, and the other is a background object. A trap zone is created around at least one of the foreground and background objects, and a trap direction is determined based at least in part on an ink characteristic of an ink associated with a color of the background and/or foreground. The trap direction may include a choke, an overprinting, a spread, and/or a knockout.

Yet other embodiments of the present invention provide methods for performing trapping on media productions of mixed object size. Such embodiments include providing a default trapping approach and a modified small element trapping approach. It is determined whether an object is a small element, and based on identification of a small element, one of the default trapping approach, the modified small element trapping approach, and a non-trapping approach is applied to the small element. In some cases, the modified small element trapping approach includes segmenting a spread portion of a trap zone. In various cases, the modified small element trapping approach includes identifying a trap direction. The trap direction may be a spread, a choke, an overprinting and a knockout.

In some instances of the embodiments, the object is determined to be a small element based at least in part on a size of a dimension of the object in relation to the size of a trap zone associated with the dimension of the object. In other instances, the object is determined to be a small element based at least in part on the overall area of the object, and in other instances the object is determined to be a small element based at least in part on a minimum dimension of the object.

Yet additional embodiments of the present invention provide systems for performing trapping on media productions of mixed object size. Such systems may include a computer readable medium with instructions executable by a computer. Some of these systems may additionally include the computer capable of executing the aforementioned instructions. The instructions may include, but are not limited to, instructions executable by a microprocessor based machine to: implement a default trapping approach; implement a modified small element trapping approach; identify an object as a small element; and based at least in part on the determination that the object is a small element, apply one of the default trapping approach, the modified small element trapping approach, and non-trapping approach.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts a flow diagram for calculating various parameters in accordance with one or more embodiments of the present invention;

FIG. 2 is a flow diagram for determining trap direction in accordacne with various embodiments of the present invention;

FIG. 3 are a series of process diagrams using an exemplary design to show the operation of one or more methods of the present invention;

FIG. 4 show a plate by plate deposition process to implement the exemplary design in accordance with various embodiments of the present invention;

FIG. 5 show a plate by plate deposition process to implement the exemplary design in accordance with other embodiments of the present invention;

FIG. 6 show the progression of a media production design using one or more trapping techniques in accordance with various embodiments of the present invention;

FIG. 7 is a flow diagram showing trap direction and ink selection in accordance with one or more embodiments of the present invention;

FIG. 8 graphically depict an ink arbitration or selection in accordance with some embodiments of the present invention;

FIG. 9 graphically depict a process of variable color trapping in accordance with various embodiments of the present invention;

FIG. 10 is a flow diagram depicting a method in accordance with some embodiments of the present invention for implementing small element trapping;

FIG. 11 illustrate a process of trapping small elements in accordance with various embodiments of the present invention; and

FIG. 12 show a process for location dependent trapping in accordance with one or more embodiments of the present invention.

### DETAILED DESCRIPTION OF THE INVENTION

The present invention is related to systems and methods for preparing media productions, and in particular to systems and methods for performing trapping between objects where one or more objects are painted with a variable color.

Some embodiments of the present invention provide methods for performing trapping where a variable color object is involved. As used herein, the term “variable color” is used in its broadest sense to mean any non-constant color. Thus, as just one example, an object may be painted with one hue but exhibits a transition in gray scale across the object. Alternatively, as another example, an object may be painted with one hue at one side of an object and another hue on another side of the object with a transition of one or more hues therebetween. As yet another example, the variance in color may be a combination of hue and gray scale. Based on the disclosure provided herein, one of ordinary skill in the art will recognize a large variety of variable colors that may be used in accordance with embodiments of the present invention.

The aforementioned methods include identifying two or more objects that are each associated with a respective color. At least one of the associated colors is a variable color. The other color may be either variable or constant. In the methods, a trap zone is defined in relation to the identified objects, and a transfer function is formed that defines a trap attribute for at least a portion of the trap zone. The trap attribute may be, but is not limited to, a trap direction and/or an ink in the trap zone. Such a trap direction may be, but is not limited to, a choke and a spread.

In some cases, the method further comprises segmenting the trap zone into a plurality of portions. The portion of the trap zone associated with the transfer function may be one of the plurality of portions, and may include a substantially constant color region within the variable color. As used herein, the term “transfer function” is used in its broadest sense to mean any description providing one or more outputs based on one or more inputs. Thus, as just one example, a transfer function may be an equation describing a particular area of a media production. Based on the disclosure provided herein, one of ordinary skill in the art will recognize a viarety of transfer functions that may be utilized in accordance with embodiments of the present invention.

In various cases, multiple transfer functions are formed for different portions of the trap zone. In such cases, the multiple transfer functions may be aggregated to form an overall transfer function describing a larger portion of the trap zone. The overall transfer function may be, for example, a step function, a continuous function, or a discontinuous function. As used herein, the term segment is used in its broadest sense to mean any area of a larger area. Thus, for example, a segment may be a signle pixel area of a larger area, a rectangular area of the larger area, or the entire larger area. Based on the disclosure provided herein, one of ordinary skill in the art will recognize a number of areas or regions that may be considered segments in accordance with one or more embodiments of the present invention.

Other embodiments of the present invention provide methods for performing trapping in relation to three or more objects. Such methods include receiving an identification of at least three objects and colors associated with the respective objects. In addition, an identification of a trap zone is received. The trap zone is associated with the aforementioned three objects. The methods further include performing a recursive trap where a color for application into at least a portion of the trap zone is identified. The identified color is selected based upon one or more of the colors associated with the respective objects related to the trap zone. As used herein, the term “recursive” is used in its broadest sense to mean applying an algorithm or formula to a result formed from an earlier algorithm or formula applied to different inputs where the earlier algorithm or formula is at least somewhat related to the later applied algorithm or formula. Thus, as just one example, a recursive trap may be performed by applying a trapping algorithm to two objects to provide a result, and then the same or related algorithm may be applied to the result and a third object to provide another result. Based on the disclosure provided herein, one of ordinary skill in the art will appreciate that while various embodiments of the present invention describe a two step recursive process, a recursive process involving three or more steps is contemplated to be within the scope of the present invention.

In various instances of the aforementioned embodiments, performing the recursive trap further includes determining a trap color and a trap direction by evaluating the colors associated with two of the three objects. From this, an interim trap color is identified as well as an interim location of the trap between the two objects. In addition, another trap color and trap direction are determined based at least in part on the interim trap color and the color associated with the third of the three objects. This other trap color is used to paint a portion of the trap zone determined by the interim location of the trap and the colors of the third object and the interim color. In various cases, both the trap direction and the interim trap location is either a choke or a spread.

As used herein, the term “trap zone” is used in its broadest sense to mean any area of potential intersection of foreground and background objects, or in some cases adjacent but not overlapping objects. The trap direction may include a choke, an overprinting, a spread, and/or a knockout. As used herein, the term “choke” is used in its broadest sense to mean any process whereby a background object is augmented at its edges such that it overlaps the edges of a corresponding foreground object. Thus, for example, a choke occurs where an ink associated with a background object encroaches the intersection between the foreground and background objects. As used herein, the term “spread” is used in its broadest sense to mean any process whereby a foreground object is augmented at its edges such that it overlaps the edges of a corresponding background object. Thus, as an example, a spread occurs where ink associated with the foreground object encroaches the intersection between the foreground and background objects. As used herein, the term “knockout” is used in its broadest sense to mean any process whereby a portion of a background object is eliminated at an area corresponding to a foreground object. Thus, as an example, a knockout may occur where a background object forms an aperture that is void of any ink in an area corresponding to a related foreground object. As used herein, the term “overprinting” is used in its broadest sense to mean any process whereby a background object is printed in its entirety, and the corresponding foreground object is printed over the background object.

In other instances of the aforementioned embodiments, performing the recursive trap further includes determining a first trap direction based at least in part on the colors associated with two of the objects, and determining a second trap direction based at least in part on the first trap direction and the color associated with the other of the three objects. These trap directions may be, but are not limited to, a choke and a spread.

In some cases of the aforementioned embodiments, the recursive trapping is performed using a “bottom up” approach. Thus, for example, in the previous scenario, the third of the three objects may be a foreground object in relation to the other two objects. In a more specific case, the first of the three objects may be at least partially behind the other two objects, the second of the three objects may be partially sandwiched between the other two objects, and the third of the three objects is on top. Selection of the interim color and/or the color used to paint the finally determined trap zone may be done by determining one or more ink characteristics as more fully described herein. In some particular cases, color selection may be done by evaluating individual inks that compose the various colors. Based on the disclosure provided herein, one of ordinary skill in the art will recognize that an approach other than a bottom up approach may be utilized in accordance with one or more embodiments of the present invention. Further, based on the disclosure provided herein, one of ordinary skill in the art will recognize that a variety of color arbitration approaches may also be used in accordance with one or more embodiments of the present invention.

As used herein, the term “foreground object” is used in its broadest sense to mean any object that is displayed as if it is atop another object and/or appears as if it may have been printed atop another object. Thus, for example, a foreground object may be a text, a line, a frame, a box, or any other graphical object that is displayed, printed and/or appears atop another object. As yet a further concrete example, a foreground object may be a line surrounded or atop a background color. As used herein, the term “background object” is used in its broadest sense to mean any object that is displayed as if it is under another object and/or appears as if it may have been printed under another object. Thus, for example, a background object may be a text, a line, a frame, a box, or any other graphical object that is displayed, printed and/or appears to be overlapped by another object. As a more particular example, a background object may be a color surrounding a foreground text.

Other embodiments of the present invention provide systems for performing-trapping in relation to three or more objects. Such systems may include a computer executing commands. As used herein, the term “computer” is used in its broadest sense to mean any microprocessor or digital signal processor based device that is capable of executing instructions. Thus, example of computers include, but are not limited to, a personal computer, a work station, a web server, a personal digital assistant, a cellular telephone, and/or the like. Based on the disclosure provided herein, one of ordinary skill in the art will recognize other types of computers that execute instructions that may be used in accordance with embodiments of the present invention.

In other cases, the aforementioned systems may include a computer readable medium that includes instructions executable by a computer. In such cases, the instructions may be executable to receive identifications of three or more objects as well as colors associated with the respective objects. In addition, instructions are included that operate to receive an identification of a trap zone that is associated with the three objects, and to perform a recursive trap. During the recursive trap, a color is selected for application into at least a potion of the identified trap zone. In some cases, the color is selected based upon one or more of the colors associated with the respective objects related to the trap zone. As used herein, the term computer readable medium is used in its broadest sense to mean any medium that is accessible in any way to a computer, and that is capable of storing instructions executable by the computer. Thus, for example, a computer readable medium may be, but is not limited to, a CD ROM, a random access memory, an eeprom, a hard disk drive, a floppy disk, a magnetic tape, a flash memory device, and/or the like. The computer readable medium such as, for example, a hard disk drive or a random access memory may be associated with a computer executing the software instructions, or maintained separate from the computer executing the software instructions. Based on the disclosure provided herein, one of ordinary skill in the art will recognize a variety of computer readable media that may be used in accordance with one or more embodiments of the present invention.

Yet other embodiments of the present invention provide methods for recursive trapping in a publishing environment. The methods include identifying a trap where the trap includes the intersection of at least three objects associated with respective colors. The methods further include determining a first ink characteristic associated with the color of the first one of the objects, determining a second ink characteristic associated with the color of the second one of the objects, and determining a third ink characteristic associated with the color of the third one of the objects. The first and second ink characteristics are compared, and based at least in part on the comparison, a controlling ink characteristic is determined. The controlling ink characteristic may be the first or the second ink characteristic. The method further includes comparing the third ink characteristic with the aforementioned controlling ink characteristic to determine a second controlling ink characteristic. The second controlling ink characteristic may be the third ink characteristic or the prior controlling ink characteristic. In some cases, the second controlling ink characteristic is used to determine a trap direction. This trap direction may be, but is not limited to, a spread or a choke.

In some instances of the aforementioned embodiments, a first of the objects is a foreground object in relation to a second of the objects. In such a case, determining the first ink characteristic associated with the color of the first object includes determining a luminance of the color associated with the first object based at least in part on the first ink. Determining the second ink characteristic associated with the color of the second object includes determining a luminance of the color of the second object based at least in part on the second ink. Comparing the first ink characteristic with the second ink characteristic includes comparing the luminance of the color of the first object with the luminance of the color of the second object. In such a case, the first controlling ink is associated with the color with greater luminance.

In the preceding instance, the third object may be a foreground color in relation to the first object. In such a case, determining the third ink characteristic associated with the color of the third object includes determining a luminance of the third color based at least in part on the third ink. Comparing the third ink characteristic with the first ink characteristic may include comparing the luminance of the third color with the luminance of the first color. In such a case, the second controlling ink is associated with the color of greater luminance. In some cases, determining the aforementioned ink characteristics may include performing two or more of the following operations in association with a particular color: evaluating a total luminance for the color based at least in part on a constituent ink used to form the color; evaluating a partial luminance for the color based at least in part on a constituent ink used to form the color; evaluating a total gray for the color based at least in part on a constituent ink used to form the color; evaluating a partial gray for the color based at least in part on a constituent ink used to form the color; and evaluating a principle gray for the first color based at least in part on a constituent ink used to form the color.

As used herein, the term “partial luminance” is used in its broadest sense to mean any value representing the lightness of a color formed with less than all constituent inks of an overall color. Thus, for example, where an overall color is formed using a CMYK process, a partial luminance may be a value representing the lightness of the Cyan component of the overall color. This may be determined, for example, by assessing the RGB value of a given ink using a formula. In one particular case, the formula is: Partial Luminance=(Red*0.3)+(Green*0.59)+(Blue*0.11). As used herein, the term “total luminance” is used in its broadest sense to mean the sum of one or more partial luminance values for an overall color. Thus, for example, where an overall color is formed using a CMYK process, the total luminance for the overall color may be the sum of the partial luminance for the Cyan component, the partial luminance of the Magenta component, the partial luminance of the Yellow component, and the partial luminance of the Black component.

As used herein, the term “gray value” is used in its broadest sense to mean any color value where all three constituent components (i.e., RGB) are equal. In some cases, gray value may be referred to herein as pixel intensity. As used herein, the term “partial gray” value is used in its broadest sense to be any value representing the gray value of less than all constituent inks of a given overall color. Thus, as just one example, a partial gray value may be a gray value associated with a Cyan component of the overall color. This may be determined, for example, by applying a formula to a constituent ink. In one particular case, the formula is: Partial Gray=(1−Ink Partial Luminance).

As used herein, the term “total gray” is used in its broadest sense to mean any hypothetical gray value formed by summing the gray values for each of the constituent inks. The total gray value is often a hypothetical value that exceeds typical black. In a four ink process, total gray may be determined using the following formula: Total Gray=(1−Ink1 Partial Luminance)+(1−Ink2 Partial Luminance)+(1−Ink3 Partial Luminance)+(1−Ink4 Partial Luminance). Also, as used herein, the term “principle gray” is defined broadly as the total gray of an object divided by the number of constituent inks used to paint the object plus an offset. The formula is as follows: Principle Gray=Total Gray/(n+offset), where n=the number of inks. The offset value is useful in the event that two or more constituent inks have an equal gray value, and in one embodiment is set between 0.0 and 0.1.

Also, as used herein, the term “rich black” is used in its broadest sense to mean any color formed from black augmented by one or more colors. Thus, for example, a rich black may be formed primarily of black and augmented with a small amount of Cyan to form a deeper black.

Colors used to paint objects may be comprised of one or more component or constituent inks. As one example, a color may be formed using a CMYK four color separation process. In such a case, the color used to paint the object may include constituent amounts of Cyan, Magenta, Yellow and Black inks. This may be further augmented by spot colors. Some embodiments of the present invention provide for trapping on an ink by ink basis, rather than on simply an overall object basis. In such embodiments, various ink characteristics may be determined including, but not limited to, evaluating a partial luminance for a color based on one or more inks used in creating the color, and there from evaluating a total luminance for the color. Other examples include evaluating a total gray for a color based on one or more inks used in creating the color; evaluating a partial gray for a color based on one or more inks used in creating the color, and/or evaluating a principle gray for a color based on one or more inks used in creating the color. Based on the disclosure provided herein, one of ordinary skill in the art will recognize other ink characteristics that may be used in relation to one or more embodiments of the present invention.

Yet other embodiments of the present invention provide methods for color arbitration in a trap zone. As used herein, the term “color arbitration” is used in its broadest sense to mean and process whereby color is selected. The methods include identifying two or more objects each associated with respective colors. In the methods, a trap zone is defined in relation to the objects, and an arbitration is performed between the colors associated with the objects. The arbitration results in the selection of a color that will be used in relation to the trap zone. In some cases, the color for the trap zone is distinct from either of the colors used in the arbitration. In various cases, the methods further include painting the selected color in at least a portion of the trap zone.

In some cases, a hue of the color of one of the objects is defined by first and second inks, and a hue of the color of the other object is defined by third and fourth inks. In some cases, the first ink is distinguished from the second ink by being different colors. Thus, for example, the first ink may be yellow while the third ink is magenta. In other cases, they are distinguished by being different percentages of the same color. Thus, for example, the first ink may be fifty percent magenta, while the third ink is twenty percent magenta. In yet other cases, the two compared inks may be identical. Based on the disclosure provided herein, one of ordinary skill in the art will recognize a variety of implementations of the first through fourth inks, and distinguishing factors thereof.

In one particular case, one of the objects is a foreground object and the other object is a background object. In such a case, arbitrating between the colors of the objects may include determining whether the luminance of the foreground object is greater than the luminance of the background object. Where it is determined that the luminance of the foreground object is greater than the luminance of the background object, an ink associated with the foreground object is included in the third color. Alternatively, where it is determined that the luminance of the foreground object is less than that of the background object, an ink associated with the background object is included in the third color.

In some cases, the methods further include determining a partial gray of the object colors. In such a case, the partial gray of, for example, the foreground object is associated with a fifth ink, and that of the background object is associated with a sixth ink. Where, for example, an ink associated with the foreground object is included in the third color, it may be determined whether the partial gray of the background object is greater than principle gray of the foreground object. Where it is determined that the partial gray of the background object is greater than the principle gray of the foreground object, the sixth ink is selected for inclusion in the third color. Alternatively, where it is determined that the partial gray of the foreground object is greater than the principle gray of the background object, the fifth ink is selected for inclusion in the third color.

In various cases, the luminance of the foreground object is compared with that of the background object. Where the luminance of the foreground object is greater than that of the background object, the first and second inks are selected for inclusion in the third color. However, where either the first or second ink is a zero ink, an ink from the background object corresponding to the zero ink is selected to replace the corresponding ink in the third color. Thus, as one particular example, where the first ink corresponds to the third ink and the first ink is zero percent magenta and the third ink is twenty percent magenta, the third ink would be selected to replace the first ink in the third color.

Yet further embodiments of the present invention provide methods for performing trapping on media productions of mixed object size. As used herein, the term “mixed object size” is used in its broadest sense to mean any grouping of two or more objects where the size of at least one of the objects is different the size of at least another of the objects as measured using any measurement approach or unit. Such embodiments include providing a default trapping approach and a modified small element trapping approach. As used herein the terms “default” trapping approach and “standard” trapping approach are used in their broadest sense to mean any approach that is generally applied to objects in the media production. As used herein, the term “modified small element trapping” approach is also used in its broadest sense to mean any trapping approach differing from a “default” or “standard” trapping approach, and applied based at least in part to objects or elements of a particular size or class. In the methods, it is determined whether an object is a small element, and based on identification of a small element, one of the default trapping approach, the modified small element trapping approach, and a non-trapping approach is applied to the small element. As used herein, the term “small element” is used in its broadest sense to mean any object that may not be treated properly by an implemented trapping approach at least in part because of a limited size or dimension of the object.

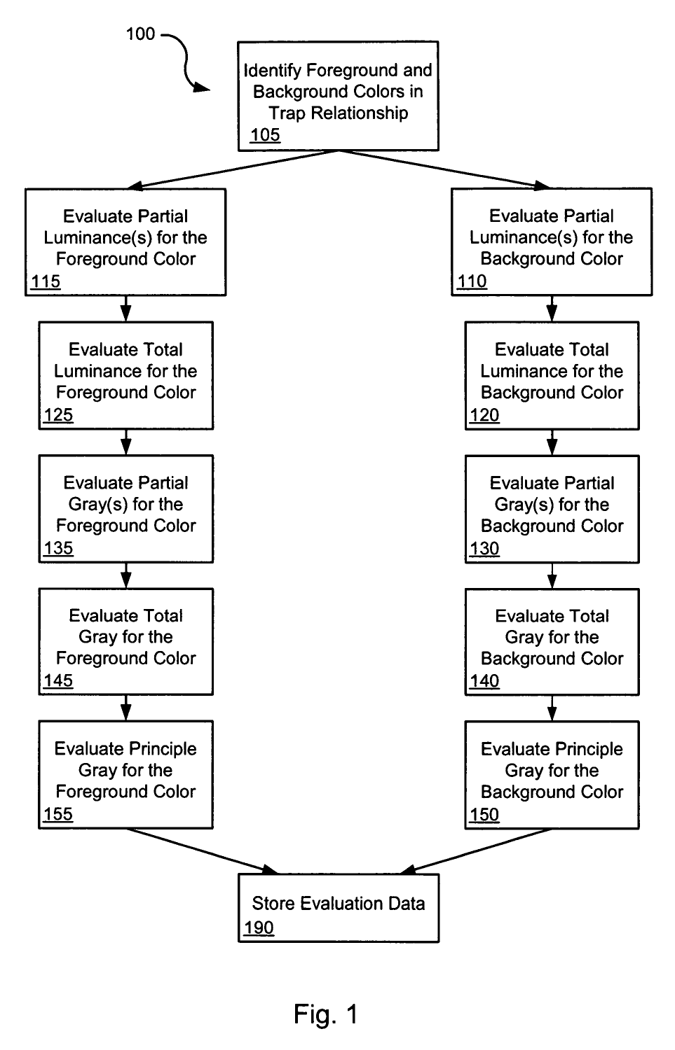

Turning to FIG. 1, a flow diagram 100 illustrates a series of evaluations performed on a foreground object and a background object in accordance with one or more embodiments of the present invention. Following flow diagram 100, a color of a background object and a color of a foreground object are identified (block 105). These identified colors are typically formed by combining two or more constituent inks in accordance with a color recipe. Thus, for example, where the colors are to be formed using a CMYK four color process, the colors may be formed of some combination of Cyan, magenta, Yellow and Black inks. Based on the disclosure provided herein, one of ordinary skill in the art will recognize a variety of color schemes and constituent inks that may be used in relation to one or more embodiments of the present invention.

A luminance value for the foreground color is evaluated (blocks 115, 125), and a luminance value of the background color is evaluated (blocks 110, 120). In one particular embodiment of the present invention, the luminance values are evaluated by calculating the partial luminance value for each of the constituent inks forming the color, and summing the calculated partial luminance values. Thus, for example, where the color is comprised of three inks: ink1, ink2 and ink3. Each of the three inks are defined using an RGB color scale, and the partial luminance for each of the three inks is calculated using the following equations:
Partial Lum_{INK1}=(Red_{INK1}*0.3)+(Green_{INK1}*0.59)+(Blue_{INK1}*0.11);
Partial Lum_{INK2}=(Red_{INK2}*0.3)+(Green_{INK2}*0.59)+(Blue_{INK2}*0.11); and
Partial Lum_{INK3}=(Red_{INK3}*0.3)+(Green_{INK3}*0.59)+(Blue_{INK3}*0.11).
The total luminance for the color is then calculated by adding the partial luminance values associated with the individual inks in accordance with the following equation:
Total Lum=Partial Lum_{INK1}+Partial Lum_{INK2}+Partial Lum_{INK3}.

In addition, or alternatively, a gray value for the foreground color is evaluated (blocks 135, 145), and a gray value for the background color is evaluated (blocks 135, 145). In one particular embodiment of the present invention, the gray values are evaluated by calculating the partial gray value for each of the constituent inks forming the color, and summing the calculated partial gray values. Thus, using the above example of three inks, a partial gray value for each of the inks may be calculated using the following equations:
Partial Gray_{INK1}=(1−Partial Lum_{INK1});
Partial Gray_{INK2}=(1−Partial Lum_{INK2}); and
Partial Gray_{INK3}=(1−Partial Lum_{INK3}).
The total gray for the color is then calculated by adding the partial gray values associated with the individual inks in accordance with the following equation:
Total Gray=Partial Gray_{INK1}+Partial Gray_{INK2}+Partial Gray_{INK3}

In some cases, a principle gray value of the foreground color and a principle gray value of the background color are also evaluated (blocks 150, 155). In one particular case, principle gray value for the particular color is determined using the following equation:
Principle Gray=Total Gray/(n+offset).
In the aforementioned equation, “n” is the number of constituent inks used to form the color, and offset is a value between 0.0 and 0.1 used to assure that distinct colors don't have exactly the same principal gray value. One or more of the aforementioned values are also stored (block 190). As will be appreciated by one of ordinary skill in the art, there are many ways of storing the values including, but not limited to, storing the values to a computer readable medium such as a hard disk drive or some other memory device.

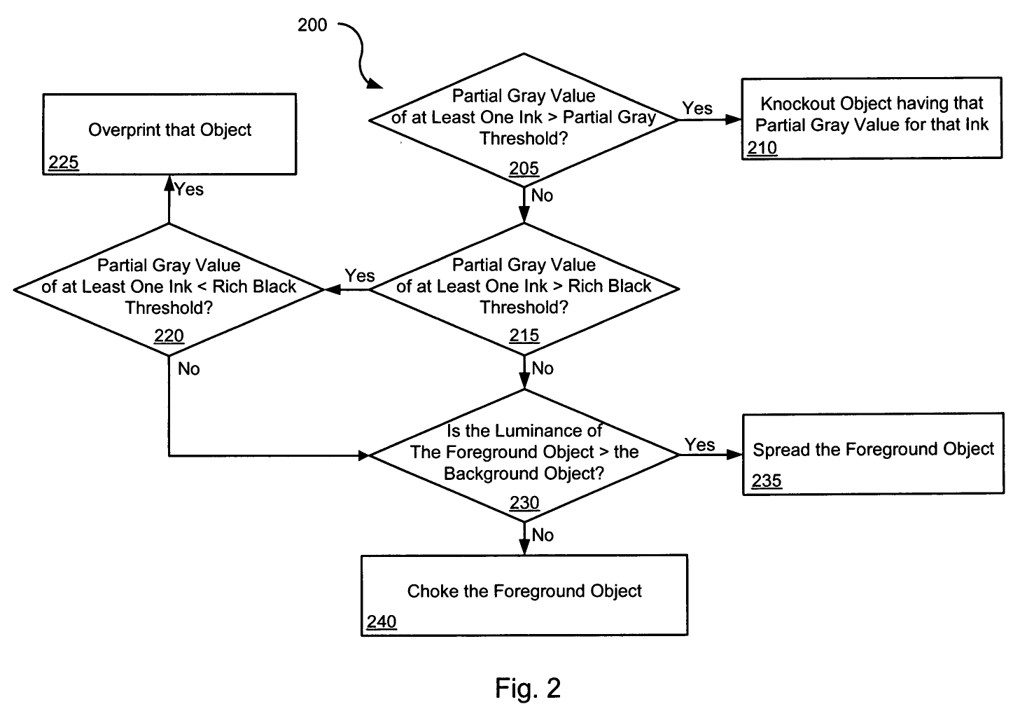

Turning to FIG. 2, a flow diagram 200 illustrates a method for trapping in accordance with one or more embodiments of the present invention. Following flow diagram 200, it is determined whether the partial gray value for any of the constituent inks used to form the background color is greater than a partial gray threshold value (block 205). The partial gray threshold value may be user programmable, and may be set at a level that will assure proper printing of the foreground object in relation to the background object. In some cases, a default partial gray threshold value is utilized where a user defined value is not provided. Where the partial gray value for any of the constituent inks is greater than the partial gray threshold value (block 205), the background object is knocked out (block 210).

Alternatively, where the partial gray value for all of the constituent inks is less than the partial gray threshold value (block 205), the background object is a candidate for overprinting (block 225). Overprinting occurs where the partial gray value for any of the constituent inks is greater than a rich black threshold (block 215), and a partial gray value of another of the constituent inks is less than the rich black threshold (block 220). The rich black threshold may be user programmable, and may be set at a level to assure proper printing of the foreground object in relation to the background object. In some cases, a default rich black threshold value is utilized where a user defined value is not provided.

In addition, it is determined if the total luminance of the foreground object is greater than the total luminance of the background object (block 230). Where the total luminance of the foreground object is greater than that of the background object (block 230), the foreground object is spread onto the background object (block 235). Alternatively, where the total luminance of the foreground object is less than that of the background object (block 230), the foreground object is choked in relation to the background object (block 240). In some cases partial luminance can be used which provides for a trap fill determination on an ink by ink basis.

In some cases, a “zero” condition is also considered where, for example, a choke or spread condition is identified based on a particular ink. In such a situation, an ink may be compared, and the trap direction based on the comparison determined to be a spread. In general, this determination would result in the location where the ink is painted being augmented or spread into the trap zone. However, where the ink is a “zero” ink (i.e., a white space or non-ink condition), an override of the determination is done and the spread is not performed. Alternatively, where the trap direction is determined to be a choke and the ink is a zero ink, an override of the determination is done and the choke is not performed. In some cases, this override condition is an exception to the general rules set forth above.

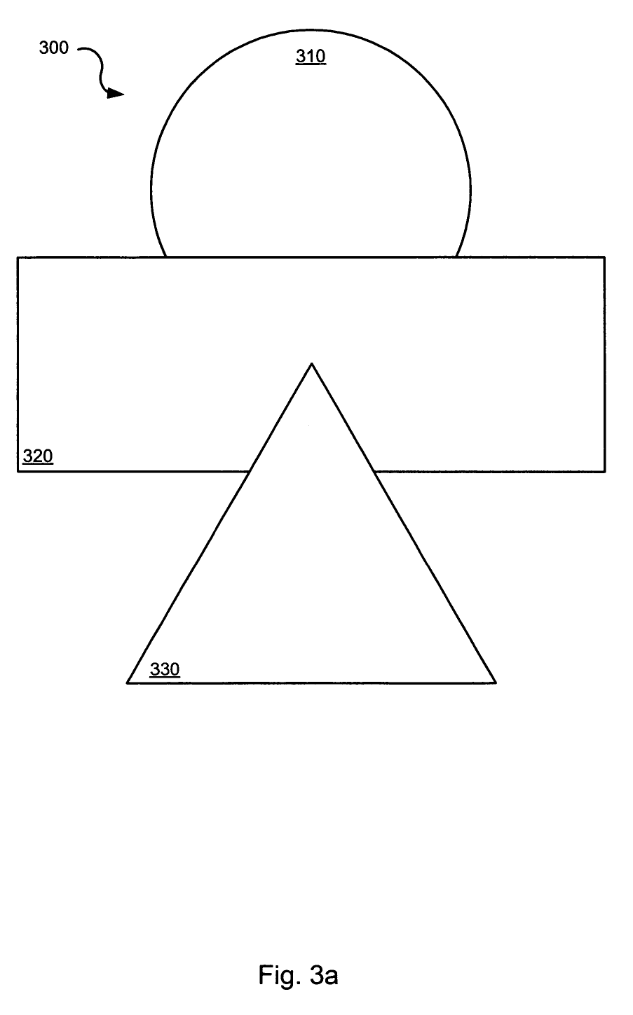

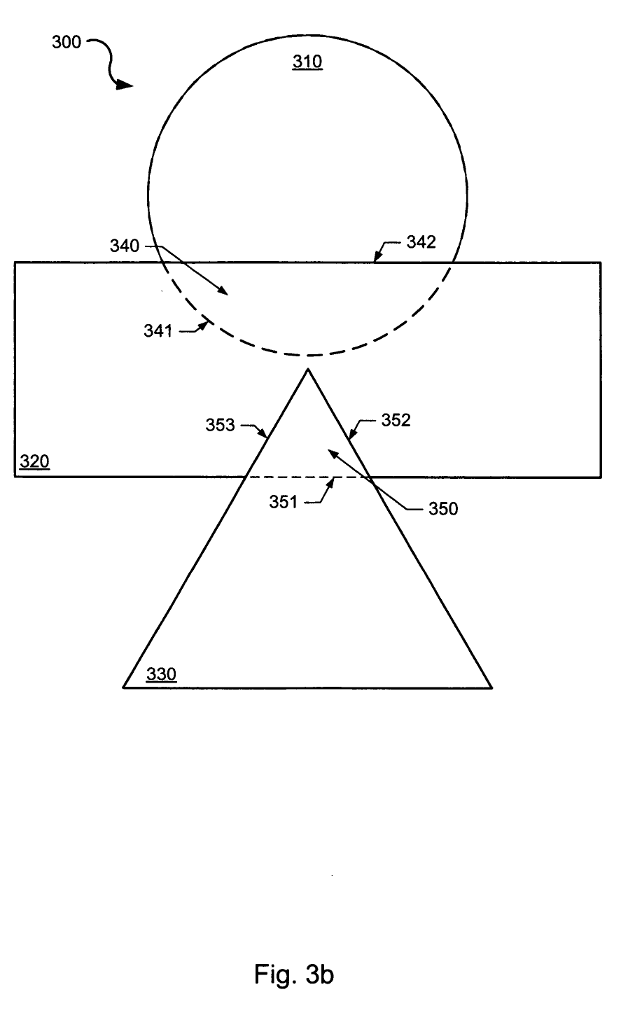

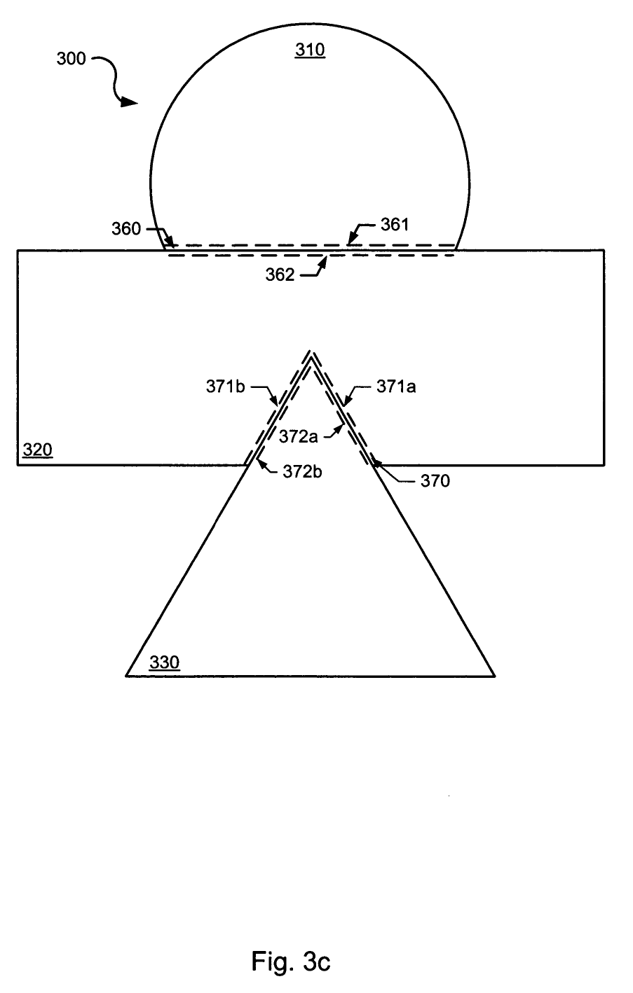

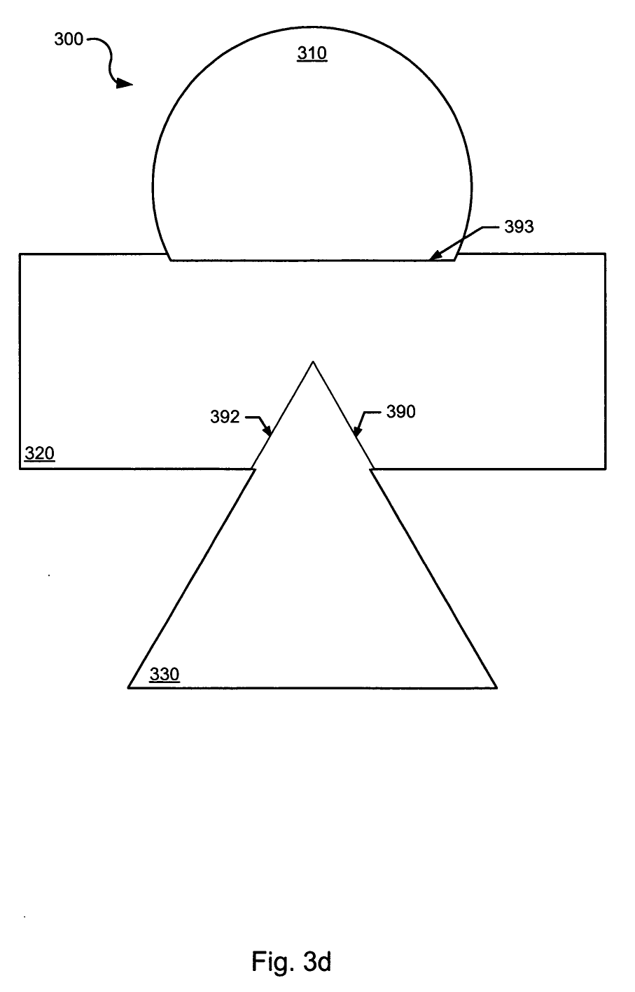

Turning to FIG. 3, an operation consistent with flow diagram 200 is shown in relation to a design 300. As shown in FIG. 3A, design 300 includes a rectangular object 320 underlying a triangular object 330 and overlying a circular object 310. FIG. 3B shows a combination of foreground and background objects defined by the intersection of rectangular object 320, triangular object 330, and circular object 310. More specifically, a portion of rectangular object 320 corresponding to an area 340 (bounded by a dashed line 341 and a portion 342 of the perimeter of rectangular object 320) is a foreground object, and a portion of circular object 310 corresponding to area 340 is a background object. Similarly, a portion of rectangular object 320 corresponding to an area 350 (bounded by a dashed line 351 and portions 351, 352 of the perimeter of triangle 330) is a background object, and a portion of triangular object 330 corresponding to area 350 is a foreground object.

One or more embodiments of the present invention include creating a trap zone around an object (foreground or background) defined at a location of intersection. FIG. 3C depicts a trap zone 360 formed in relation to the object(s) associated with the area 340 (not shown on FIG. 3C), and a trap zone 370 formed in relation to the object(s) associated with the area 350 (not shown in FIG. 3C). Trap zone 360 is defined as an area between a dashed line 361 and another dashed line 362. In some cases, the size of trap zone 360 (i.e., distance from dashed line 361 to dashed line 362) may be user defined, or a default value may be used. In such cases, a parameter may be set in a program, and when a trap zone is to be formed, it is formed to a size defined by the parameter. Based on the disclosure provided herein, one of ordinary skill in the art will appreciate a variety of methods and/or approaches that may be used to set the size of a trap zone. For example, it may be that the size of the trap zone is set automatically by importing a determined potential mis-registration for a selected printing press. In such a case, a parameter controlling the size of the trap zone may be set to a value used to define the operation of the selected press.

Trap zone 370 is defined as an area between dashed line 371 and dashed line 372. Similar to trap zone 360, the size of trap zone 370 (i.e., distance between dashed line 371 and dashed line 372) may be user defined, or in other cases automatically determined. Where the size of trap zone 370 is automatically determined, it may be determined using an approach similar to that described in relation to trap zone 360.

The direction of the trap may be determined through use of a method such as that described in relation to FIG. 2. Thus, for example, where the direction of the trap associated with trap zone 360 is determined to be a choke, the ink associated with circular object 310 encroaches on rectangular object 320 up to the boundary defined by dashed line 362. Alternatively, where the direction of the trap associated with trap zone 370 is determined to be a spread, the ink associated with rectangular object 320 encroaches on circular object 310 up to the boundary defined by dashed line 361. Using another example, where the direction of the trap associated with trap zone 370 is determined to be a choke, the ink associated with rectangular object 320 encroaches on triangular object 330 up to the boundary defined by dashed line 372. In contrast, where the direction of the trap associated with trap zone 370 is determined to be a spread, the ink associated with triangular object 330 encroaches on rectangular object 320 up to the boundary defined by dashed line 371.

Turning to FIG. 3D, a printed version of design 300 is shown where the direction of the trap at the intersection of circular object 310 and rectangular object 320 is a choke. As stated above, this results in the background object (circular object 310) encroaching on the foreground object (rectangular object 320). The direction of the trap at the intersection of triangular object 330 and rectangular object 320 is a spread. As stated above, this results in the foreground object (triangular object 330) encroaching on the background object (rectangular object 320).

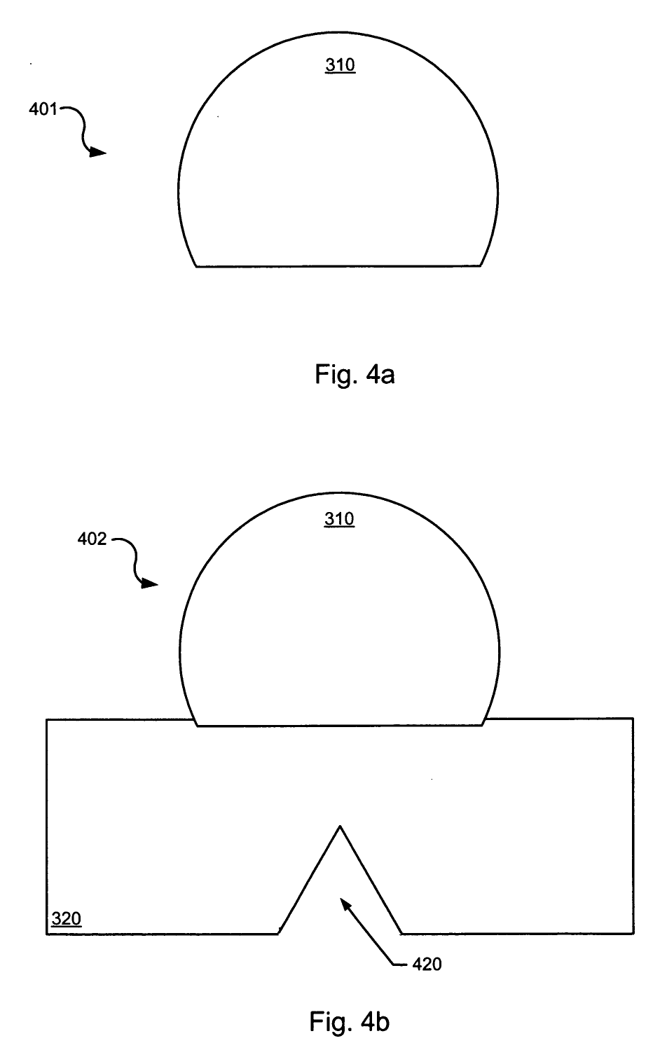

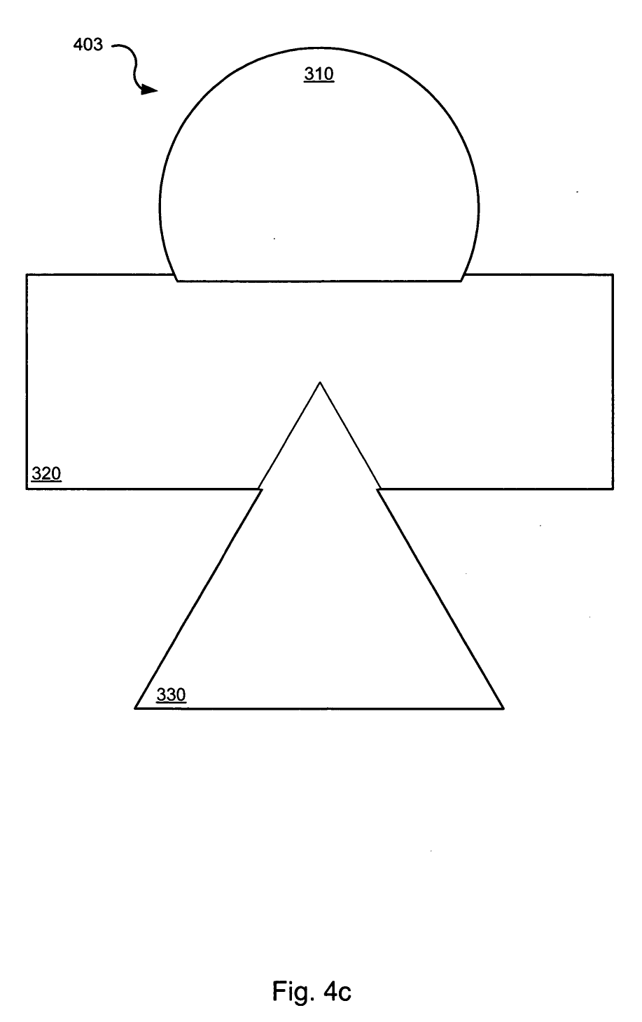

Turning to FIG. 4, a plate by plate deposition process to implement the exemplary design of FIG. 3 is illustrated. For the purposes of this discussion, it is assumed that each of objects 310, 320, 330 are formed during a single plate process that is mutually exclusive of the single plate processes used to form the other objects. As depicted in FIG. 4A, a plate 401 is first painted that includes object 310 formed such that it encroaches in the trap zone as described in relation to FIG. 3. Next, as shown in FIG. 4B, a plate 402 is painted that includes object 320 with a knockout 420, and with object 310 encroaching thereon. Finally, as shown in FIG. 4C, a plate 403 is painted such that a portion of object 330 is formed in knockout 420.

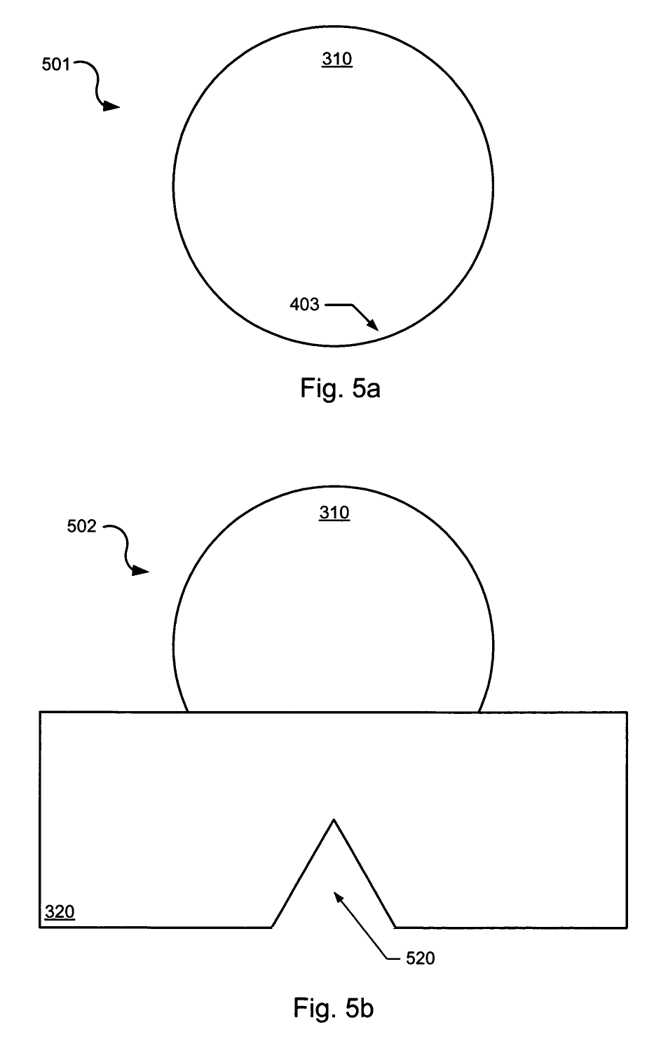

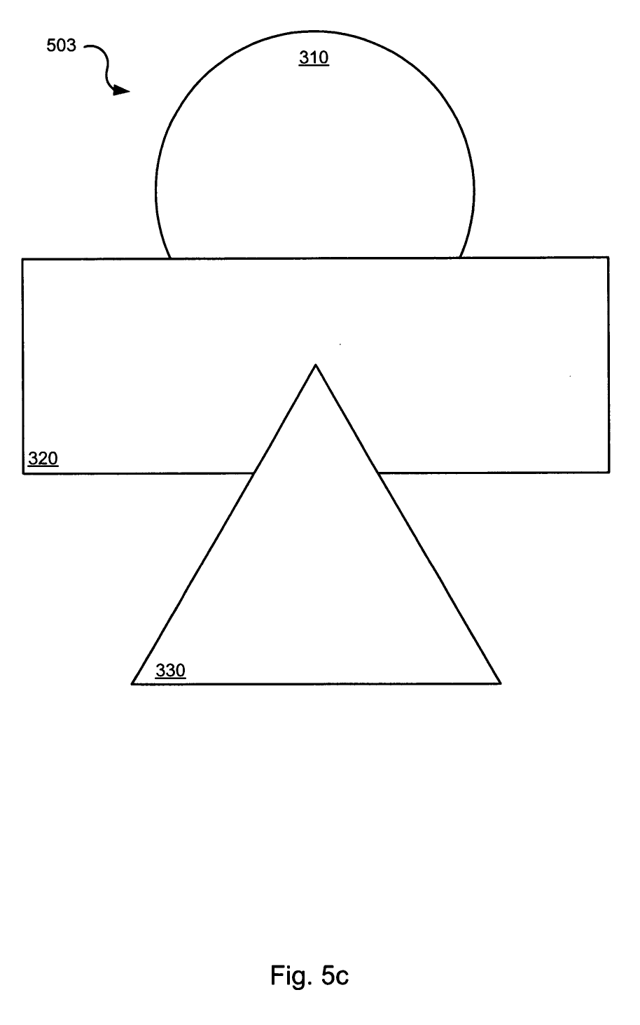

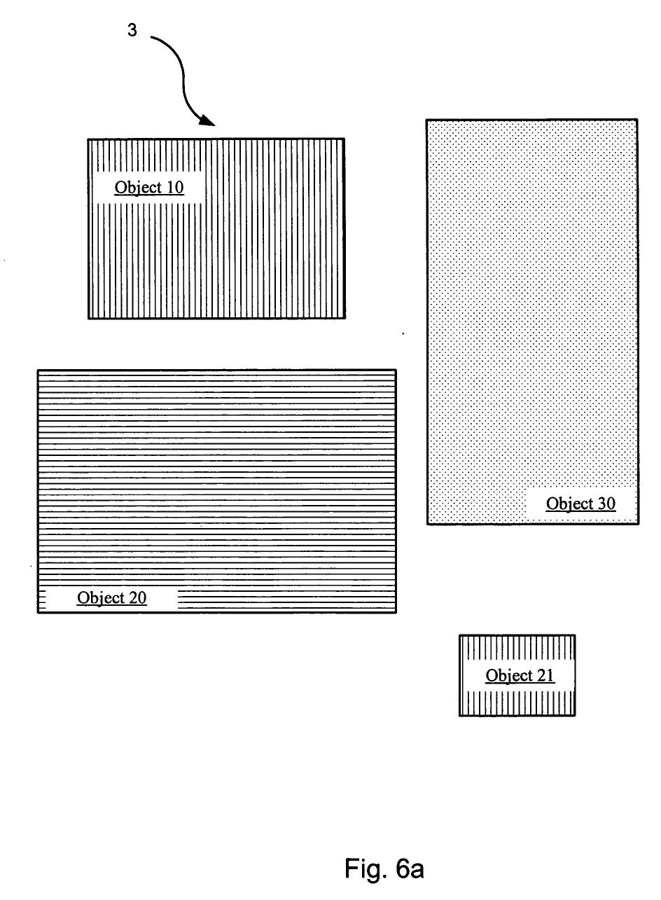

Turning to FIG. 5, another plate by plate deposition process to implement the exemplary design of FIG. 3 is illustrated. Similar to that of FIG. 4, for the purposes of this discussion, it is assumed that each of objects 310, 320, 330 are formed during a single plate process that is mutually exclusive of the single plate processes used to form the other objects. Further, it is assumed that the trap direction was to be an overlap and a cutout. As depicted in FIG. 5A, a plate 501 is first painted that includes the entirety of object 310. Next, as shown in FIG. 5B, a plate 502 is painted that includes object 320 with a knockout 520, and overlapping a portion of object 310. Finally, as shown in FIG. 5C, a plate 503 is painted such that a portion of object 330 is is formed in knockout 520.

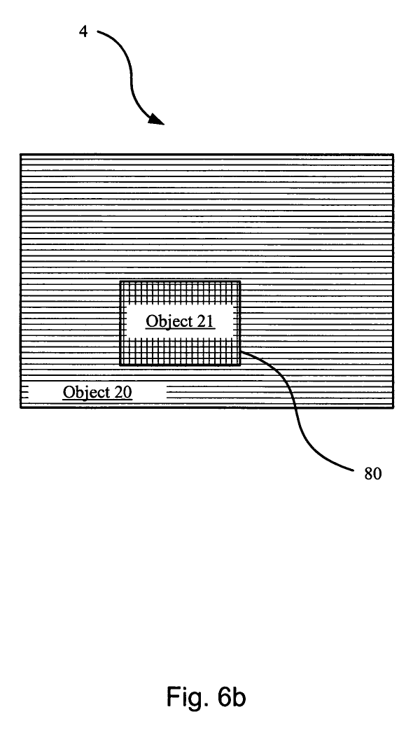

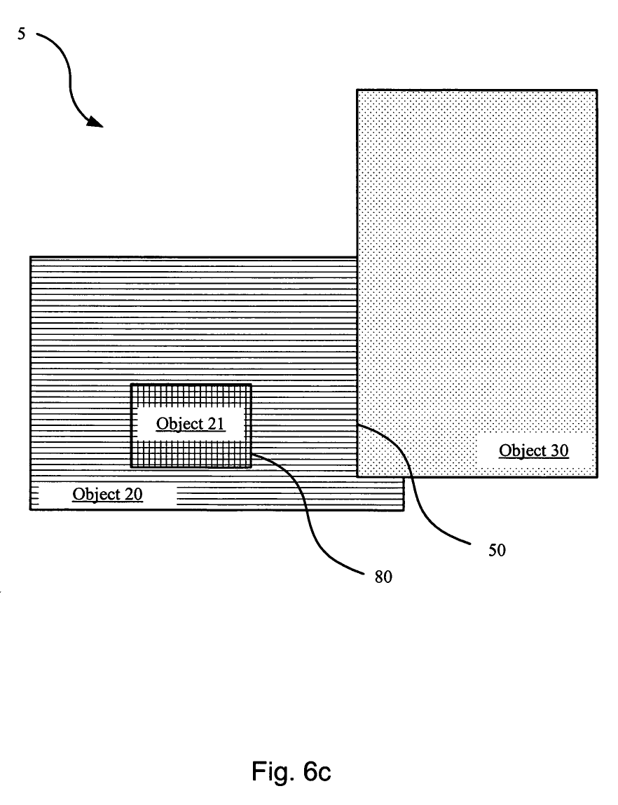

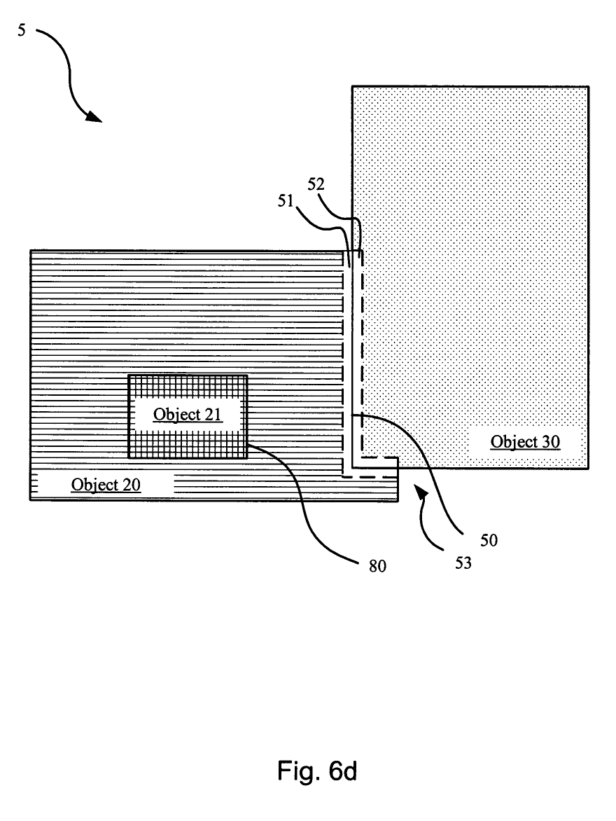

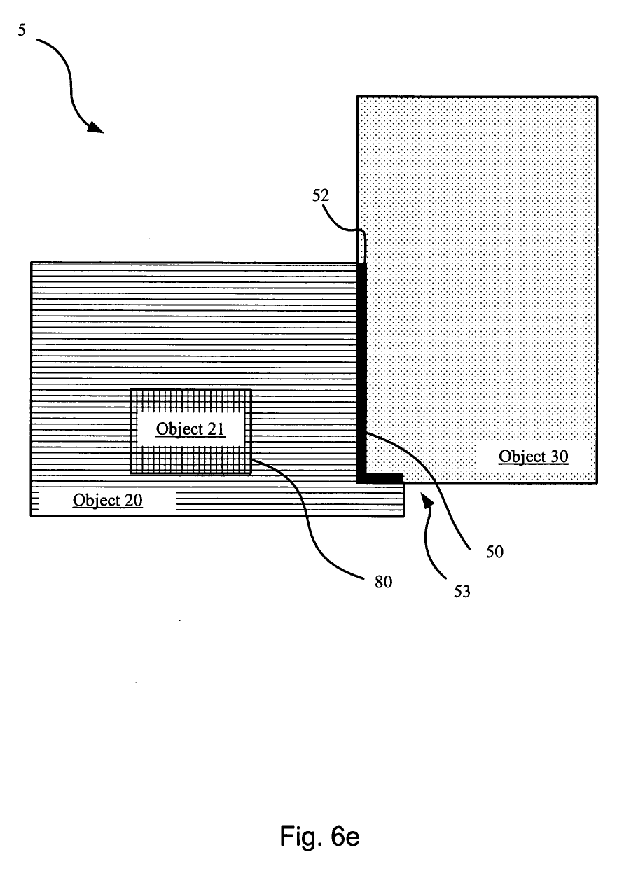

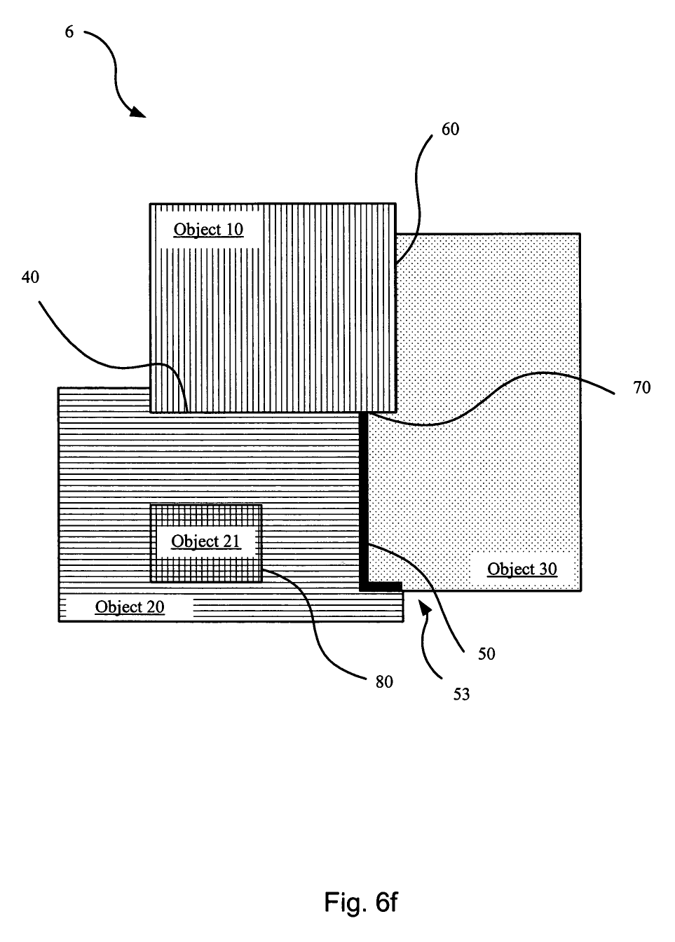

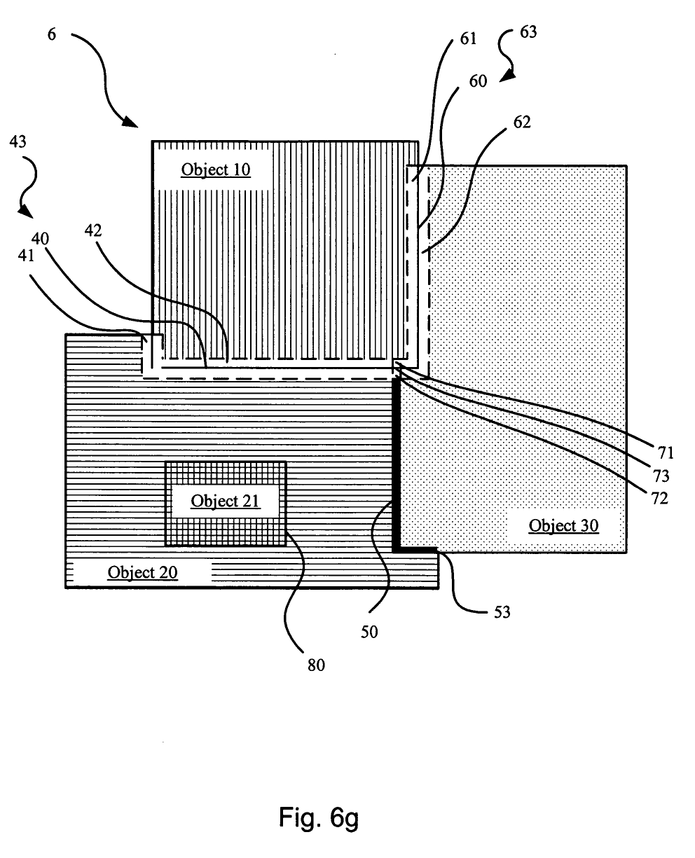

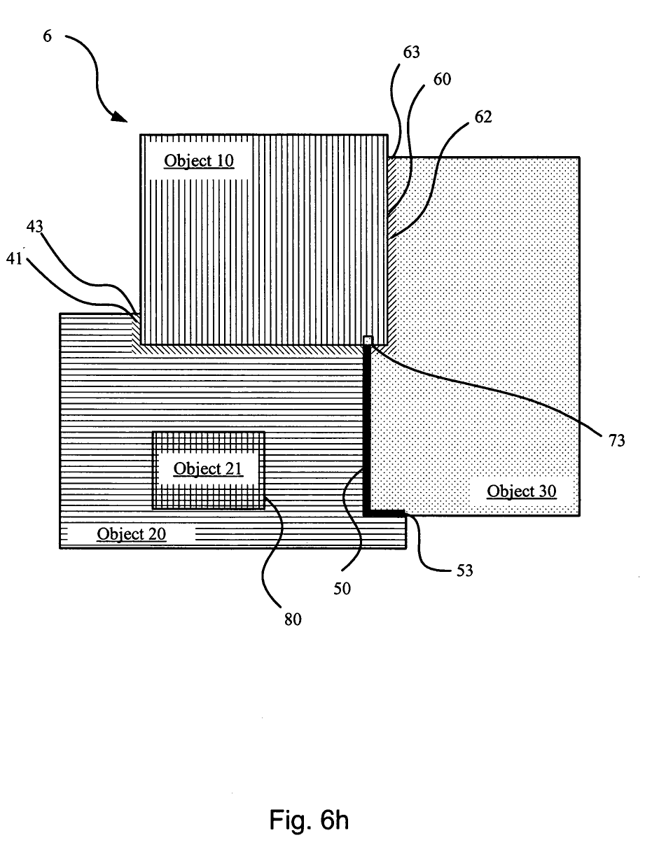

Turning to FIG. 6, a progression (indicated by numbers 3-6) is depicted of a media production design using one or more trapping techniques in accordance with various embodiments of the present invention. In particular, FIG. 6A shows a group 3 of four objects 10, 20, 21, 30 that are each painted with a particular color. More specifically, object 10 and object 21 are painted with a color represented by a vertical line pattern. Object 20 is painted with a color represented by a horizontal line pattern, and object 30 is painted with a color represented by a dotted pattern. The respective colors may be solid colors or variable colors as are more fully described below. Further, one of ordinary skill in the art will recognize that the aforementioned patterns may represent any color created using any approach. Thus, as just one example, the aforementioned colors may be formed by mixing a number of constituent inks. As a more particular example, where a CMYK process is to be used for printing a given media production, the aforementioned colors may be some combination of Cyan, Magenta, Yellow and/or Black inks. Thus, a given color may be described as a particular color or as a color derived from a certain recipe of constituent inks.

Turning to FIG. 6B, an assembly 4 of two objects 20, 21 is shown. Assembly 4 may be created as a designer begins putting objects into a final media production. In this case, object 20 is a foreground object and object 21 is a background object. The color of the intersection of object 20 and object 21 is shown as a combination of the horizontal lines of object 20 and the vertical lines of object 21 to suggest that object 20 overprints object 21. Thus, a composite color formed by mixing the color of object 20 and the color of object 21 is painted at the location of object 21. Alternatively (not shown), where object 20 is to occlude or knockout object 21, the color of object 20 would be painted at the location of object 21. An overprint or knockout condition may be indicated by a user creating the design, or may be determined as described in relation to FIG. 2 above. The placement of object 20 at least partially over object 21 results in a trap zone 80 which in this case is the location of object 21 in relation to object 20.

In one instance, a particular bottom up approach to trap zone 80 is utilized. In the approach, object 21 is painted followed by the painting of object 20. An insiders test is then performed to determine whether object 20 completely covers object 21. Where the insiders test indicates that object 20 completely covers object 21, it is determined whether the trap direction is an overprint or a knockout. Again, determining whether an overprint or knockout condition exists may be done as described in relation to FIG. 2 above, or may be user selected. Where it is a knockout (which is not shown), the color of object 20 is used to paint the location of object 21 (i.e, the trap zone in this case). Alternatively, where it is an overprint (as shown), the colors of object 20 and object 21 are used to determine another color that is painted in the trap zone. This process may be one form of color selection generically referred to herein as color arbitration.

In one particular instance, the color selection is performed by including all mutually exclusive inks from the two colors into the color that will be painted in trap zone 80. Further, where non-mutually exclusive inks are included in the two colors, then the value of the non-mutually exclusive ink of the foreground object (i.e., object 20) is used, and the value of the non-mutually exclusive ink of the background object (i.e., object 21) is ignored. As a more concrete example of the general rules stated above, assume the color of object 20 is formed of an ink recipe consisting of 0% Cyan, 100% Magenta and 75% Yellow, and that the color of object 21 is formed of an ink recipe consisting of 100% Cyan, 0% Magenta and 40% Yellow. In this case, the Cyan and Magenta inks are mutually exclusive (i.e., one of the two colors includes a 0% for the particular ink), and the foreground object (i.e., object 20) utilizes 75% Yellow. Thus, the color used to paint the location of object 21 composed of the following constituent inks: 100% Cyan, 100% Magenta, and 75% Yellow. Where, unlike that previously described, object 21 was the foreground object and object 20 was the background object, the following constitutent inks would be used to form the color in the trap zone: 100% Cyan, 100% Magenta, and 40% Yellow. Based on the disclosure provided herein, one of ordinary skill in the art will recognize a variety of colors that may be selected to paint the trap zone based on the colors present in two overprint colors.

It is also informative to describe a scenario where a third object (not shown) associated with another color is placed on top of trap zone 80. In this case, a recursive trap may be performed. Where, for example, the third object (not shown) is placed on top of both object 20 and object 21 at the location of trap zone 80, the third object is considered a foreground object in relation to both object 20 and object 21. In such a case, the previously described trap between object 20 and object 21 at trap zone 80 is performed resulting in a color selection to be painted at the location of trap zone 80. Then, the same trap process may be performed between the third, foreground object (not shown) and the results of the previous trap between object 20 and object 21. In this case, the trap between object 20 and object 21 resulted in an interim object that is the size and location of trap zone 80, and painted the selected color (i.e., in this case the interim color). When the trap with the third, foreground object (not shown) is performed, it may be the same process as that described in relation to object 20 and object 21, but as applied to the interim object and the third, foreground object (not shown). Another example of recursive trapping is described below. This is an example of recursive trapping, and other examples are provided below.

Turning to FIG. 6C, an assembly 5 that includes assembly 4 augmented with object 30 is shown. Similar to assembly 4, assembly 5 may be created as a designer puts objects into a final media production. In this case, object 20 is a foreground object and object 21 is a background object in relation to each other, and object 30 is a foreground object in relation to object 20. The overlap of object 30 and object 20 results in a boundary 50. In this case, object 30 is a knockout of object 20. Thus, the color of object 30 (depicted as a dotted pattern) occludes the background color (i.e., the color of object 20 shown as horizontal lines).

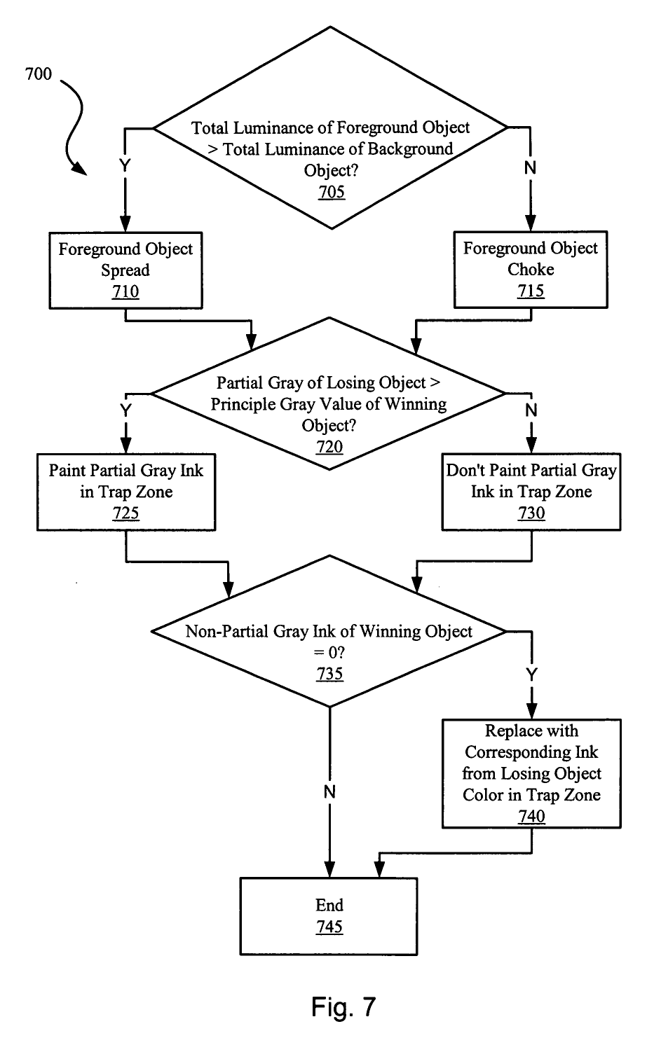

Turning to FIG. 6D, a trap zone 53 including a choke region 52 and a spread region 51 are defined around boundary 50. In some cases, as more fully described herein, when the trap region is painted it is only one of the spread region or choke region that is effected based on a determination of a trap direction. This was discussed in relation to FIG. 2 above, and is again touched upon in describing FIG. 7 below. The trap direction is determined by comparing the color of foreground object 30 with that of background object 20 as more fully described below. For discussion purposes, it is assumed that the trap direction is a choke, and thus the area in which the determined color of the trap zone will be painted is choke region 52. The color that is painted in the trap zone may be the same as that of object 30, or distinct there from. The process of selecting the color to be painted in the trap zone is more fully described in relation to FIG. 7 below. For the purposes of this immediate discussion, it is merely recognized that a color is selected for trap zone 53 consisting of choke region 52. Upon reading this discussion, one of ordinary skill in the art will recognize that the trap direction may be found to be a spread, in which case a similar approach would be performed to select a color for painting spread region 51. FIG. 6E shows assembly 5 with trap zone 53 painted with a color represented as a solid black area. It will be recognized by one of orndinary skill in the art that the solid black area represents any selected color and is not necessarily painted black.

Turning now to FIG. 6F, an assembly 6 that includes assembly 5 augmented with object 10 is shown. Similar to assembly 4 and assembly 5, assembly 6 may be created as a designer puts objects into a final media production. In this case, object 20 is a foreground object and object 21 is a background object in relation to each other, object 30 is a foreground object in relation to object 20 and a backgound object in relation to object 10, and object 10 is a foreground object in relation to object 20 and object 30. The overlap of object 10 and object 30 results in a boundary 60, and the overlap of object 10 and object 20 results in a boundary 40. In addition, object 10 overlaps trap zone 53 resulting in a boundary 70. In this case, object 100 is a knockout of object 20, object 30, and trap zone 53. Thus, the color of object 10 (depicted as a vertical line pattern) occludes the background colors (i.e., the color of object 20 shown as a horizontal line pattern, the color of object 30 shown as a dotted pattern, and the color of trap zone 53 shown as a solid black pattern).

Turning to FIG. 6G, a trap zone 63 including a choke region 61 and a spread region 62 is defined around boundary 60; a trap zone 43 including a choke region 42 and a spread region 41 is defined around boundary 40; and a trap zone 73 including a choke region 71 and a spread region 72 is defined around boundary 70. As will be appreciated from the following discussion, performing a trap at trap zone 73 will involve a trap of a trap. More specifically, at trap zone 73, a trap between object 10 and trap zone 53 is performed. This is another example of recursive trpping in accordance with some embodiments of the present invention.

In some cases, as more fully described herein, when the trap region is painted it is only one of the spread region or choke region that is effected based on a determination of a trap direction. This was discussed in relation to FIG. 2 above, and is again touched upon in describing FIG. 7 below. In the case of trap zone 43, the trap direction is determined by comparing the color of foreground object 10 with that of background object 20. For discussion purposes, it is assumed that the trap direction is a spread, and thus the area in which the determined color of the trap zone will be painted is spread region 41. The color that is painted in trap zone 43 may be the same as that of object 10, or distinct there from. The process of selecting the color to be painted in the trap zone is again more fully described in relation to FIG. 7 below. For the purposes of this immediate discussion, it is merely recognized that a color is selected for trap zone 43 consisting of spread region 41. Upon reading this discussion, one of ordinary skill in the art will recognize that the trap direction may be found to be a choke (not shown), in which case a similar approach would be performed to select a color for painting choke region 42.

Similarly, in the case of trap zone 63, the trap direction is determined by comparing the color of foreground object 10 with that of background object 30. For discussion purposes, it is assumed that the trap direction is a spread, and thus the area in which the determined color of the trap zone will be painted is spread region 62. The color that is painted in trap zone 63 may be the same as that of object 10, or distinct there from. The process of selecting the color to be painted in the trap zone is more fully described in relation to FIG. 7 below. For the purposes of this immediate discussion, it is merely recognized that a color is selected for trap zone 63 consisting of spread region 62. Upon reading this discussion, one of ordinary skill in the art will recognize that the trap direction may be found to be a choke (not shown), in which case a similar approach would be performed to select a color for painting choke region 61.

Similarly, in the case of trap zone 73, the trap direction is determined by comparing the color of foreground object 10 with that of trap zone 53. For discussion purposes, it is assumed that the trap direction is a choke, and thus the area in which the determined color of the trap zone will be painted is choke region 71. The color that is painted in trap zone 73 may be the same as that of object 10, or distinct there from. The process of selecting the color to be painted in the trap zone is again more fully described in relation to FIG. 7 below. For the purposes of this immediate discussion, it is merely recognized that a color is selected for trap zone 73 consisting of choke region 71. Upon reading this discussion, one of ordinary skill in the art will recognize that the trap direction may be found to be a spread (not shown), in which case a similar approach would be performed to select a color for painting spread region 72.

FIG. 6H shows assembly 6 with trap zone 43 painted with a left diagonal pattern that similar to the other patterns of assembly 6 represents any color selected during the trapping process. In addition, assembly 6 is shown with trap zone 63 painted with a right diagonal pattern representing a color selected during a trap process, and trap zone 73 painted with a dotted pattern representing a color selected during the recursive trap between trap zone 53 and object 10. Again, it will be recognized by one of ordinary skill in the art that the patterns used to represent color may represent any number of different colors that may be selected in accordance with different embodiments of the present invention.

Turning to FIG. 7, a flow diagram 700 depicts a method for determining trap direction and ink selection in accordance with one or more embodiments of the present invention. Following flow diagram 700, a total luminance of a foreground object is compared with the total luminance of a background object (block 705). Where the total luminance of the foreground object is greater than or equal to that of the background object (block 705), the trap direction is a spread (block 710). Alternatively, where the total luminance of the background object is greater than that of the foreground object (block 705), the trap direction is a choke (block 715).

Thus, using objects of FIG. 6 to provide more concrete examples, the total luminance of foreground object 10 would be compared with the total luminance of background object 20. In the depiction, the trap direction is a spread, and thus it can be concluded that the total luminance of the color associated with object 10 is greater than or equal to that of object 20. The opposite example is shown where the total luminance of foreground object 30 is compared with that of background object 20 resulting in a choke. In the depicted case, it can be concluded that the total luminance of the color associated with object 30 is less than that associated with object 20. The aforementioned examples are, of course, merely exemplary and one of ordinary skill in the art will recognize a myriad of other possible examples that could be used.

In addition, an exemplary ink selection or arbitration is performed (blocks 720-740). As an initial condition, the constituent inks of the object exhibiting the greatest value of luminance (block 705) are selected to form the color that will be applied to the trap zone. In addition, the process includes comparing the partial gray value of the losing object with the principle gray of the winning object (block 720). In this case, the winning object is the object with the highest luminance value tested in block 705 or in the case of a tie, the foreground object (i.e., the foreground object where the trap direction is a spread, or the backgound object where the trap direction is a choke). Where the partial gray value of the losing object is greater than the principle gray value of the winning object (block 720), the constituent ink of the losing object color that is responsible for the partial gray of the color replaces the corresponding ink in the color that will be applied to the trap zone (block 725). Alternatively, where the partial gray value of the losing object is less than or equal to the principle gray value of the winning object (block 720), the constituent inks of the winning object color are retained (block 730).

Further, it is determined whether any of the non-partial gray inks (i.e., the inks that combine to form the hue) of the winning object color have a zero value (block 735). Where a zero value is identified (block 735), the corresponding ink from the losing object color is used to replace the zero value ink of the winning object for inclusion in the color that will be painted in the trap zone (block 740). At this point, the inks that will form the color applied to the trap zone have been determined (block 745).

Using a concrete example again from the objects of FIG. 6, assume the color of object 10 is formed of 10% A ink, 40% B ink, and 0% C ink, and the color of object 20 is formed of 11% A ink, 35% B ink, and 20% C ink. For simplicity, is is assumed that the B ink of the color of object 20 forms the partial gray value, and that the partial gray value of object 20 is greater than the principle gray value of object 10. Also, because the direction of trap zone 43 is a spread, it will be assumed that the aforementioned ink recipe for the color of object 10 has a greater luminance than the recipe for the color of object 20 (blocks 705-715). This results in a default color selection that will be applied to trap zone 43 that is the same as the the color of object 10, or 10% A ink, 40% B ink, and 0% C ink.

Next, the partial gray value for the color of object 20 is compared with the principle gray of object 10 (block 720). In this case, because the partial gray value of the losing object is greater than the principle gray value of the winning object (block 720), the partial gray ink of the color of object 20 replaces the corresponding ink from object 10 in the trap zone (block 725). This results in a color for the trap zone consisting of: 10% A ink, 35% B ink, and 0% C ink. Further, it is determined that one of the non-partial gray inks (e.g., A ink and C ink) of the color of object 10 is a zero value ink (i.e., 0% C ink) (block 735). In such a case, the C ink value from the color of object 20 replaces the C ink value from the color of object 10. This results in a color for the trap zone consisting of: 10% A ink, 35% B ink, and 20% C ink. This color is used to paint trap zone 43. It should be noted that the aforementioned example is merely exemplary and that the ABC inks used are a generic way of referring to any number of ink schemes or color pallettes. Based on the disclosure provided herein, one of ordinary skill in the art could apply the process to a myriad of compared colors to determine a color for application in a trap zone.

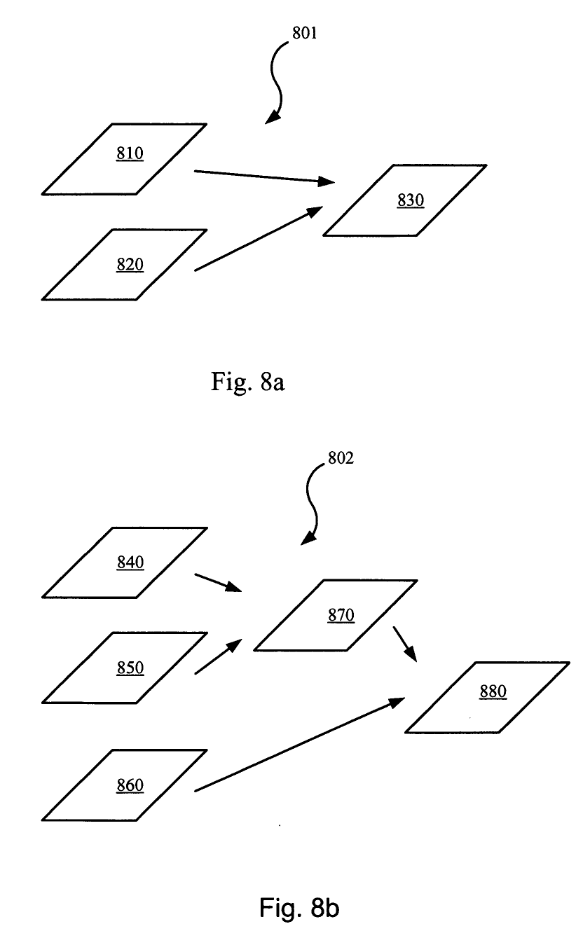

FIG. 8 illustrate graphical depictions 801, 802 of ink arbitrations in accordance with some embodiments of the present invention. Depiction 801 illustrates an ink arbitration between two object colors 810, 820 resulting in an object color 830. Such arbitration may be performed as described in relation to FIG. 7 above. In contrast, depiction 802 illustrates a recursive trap involving recursive application of the ink arbitration rules described in relation to FIG. 7 to perform an ink arbitration in relation to three object colors 840, 850, 860. As shown, an interim object color 870 is formed through an ink arbitration between object color 840 and object color 850. Then, a second arbitration is performed between interim object color 870 and an object color 860 to form object color 880.

Based on the disclosure provided herein, and in paritcular to the discussion for FIGS. 6 and 8, one of ordinary skill in the art will recognize that recursive trapping including recursive color arbitration and/or recursive determination of trap direction may be performed in relation to three or more objects and/or object colors. As an example, it could be that object color 880 is another interim object color that may be used in another trapping scenario to select yet another color. Further, it should be recognized that it is possible to perform a recursive trap where two interim traps (i.e., the result of performing trap direction analysis and/or ink arbitration) are compared to create a final trap. Thus, as just one example, it may be possible to compare two object colors to create a first interim color, and then to compare to other object colors to create a second interim color. Then, the two interim colors may be compared to select another color that may be applied in a trap zone. Based on the disclosure provided herein, one of ordinary skill in the art will recognize that the same approach may be applied to determining trap direction where such is desirable. Of note, this may result in an approach that is not a bottom-up approach.

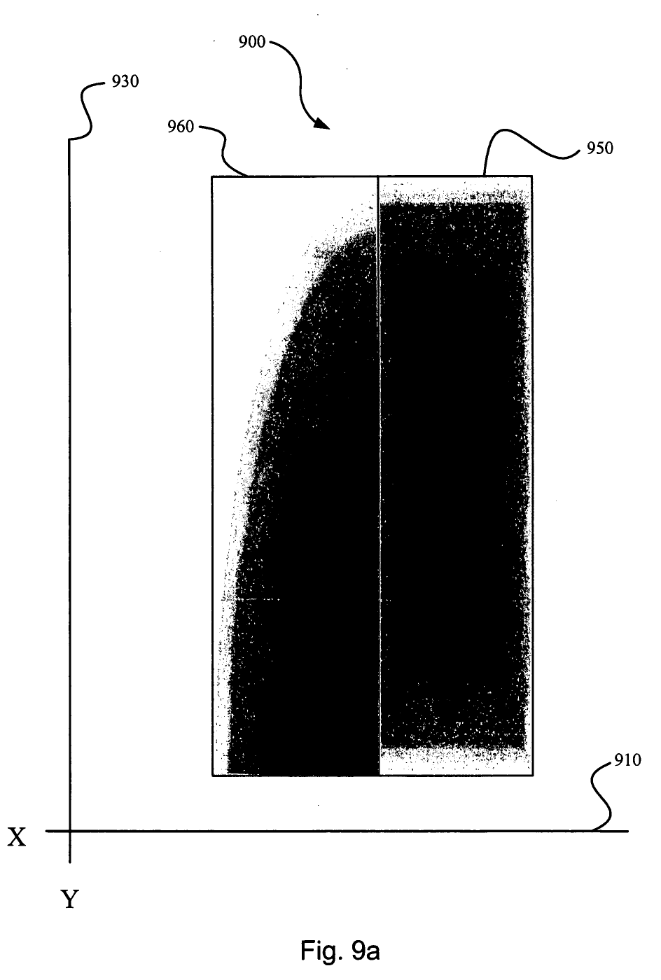

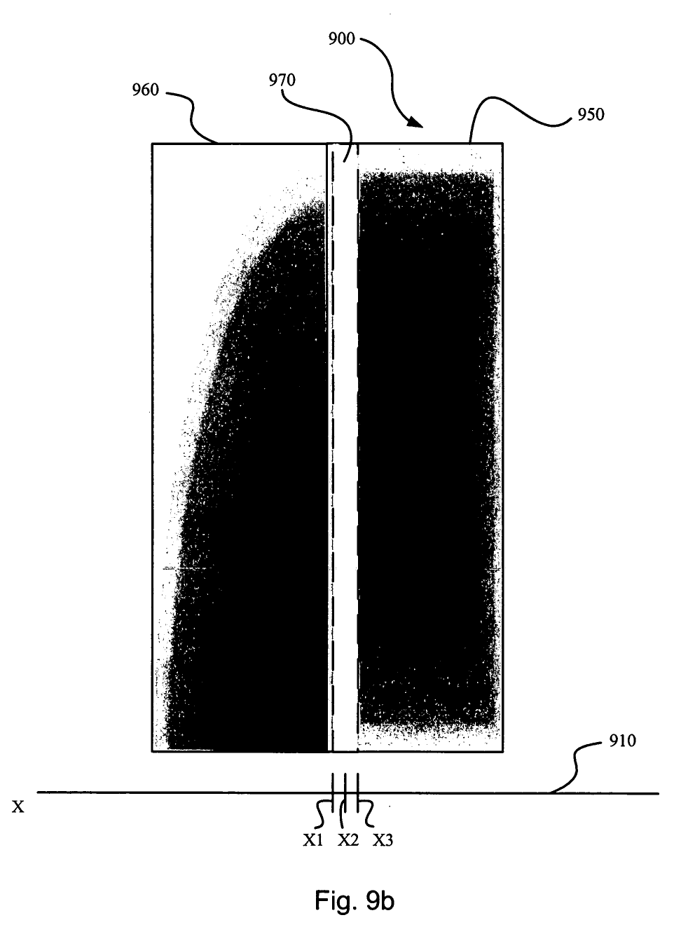

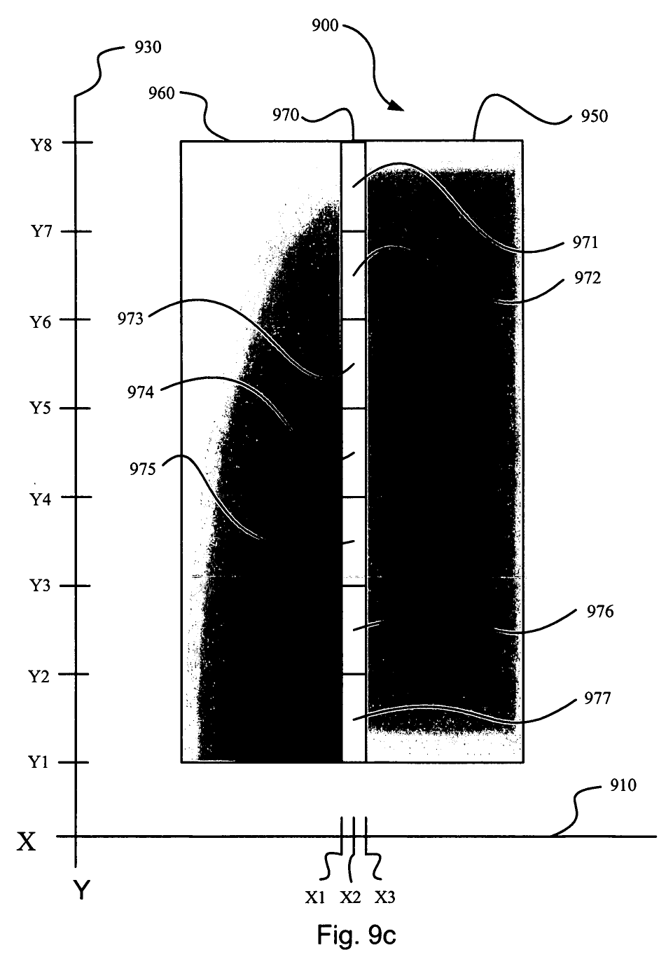

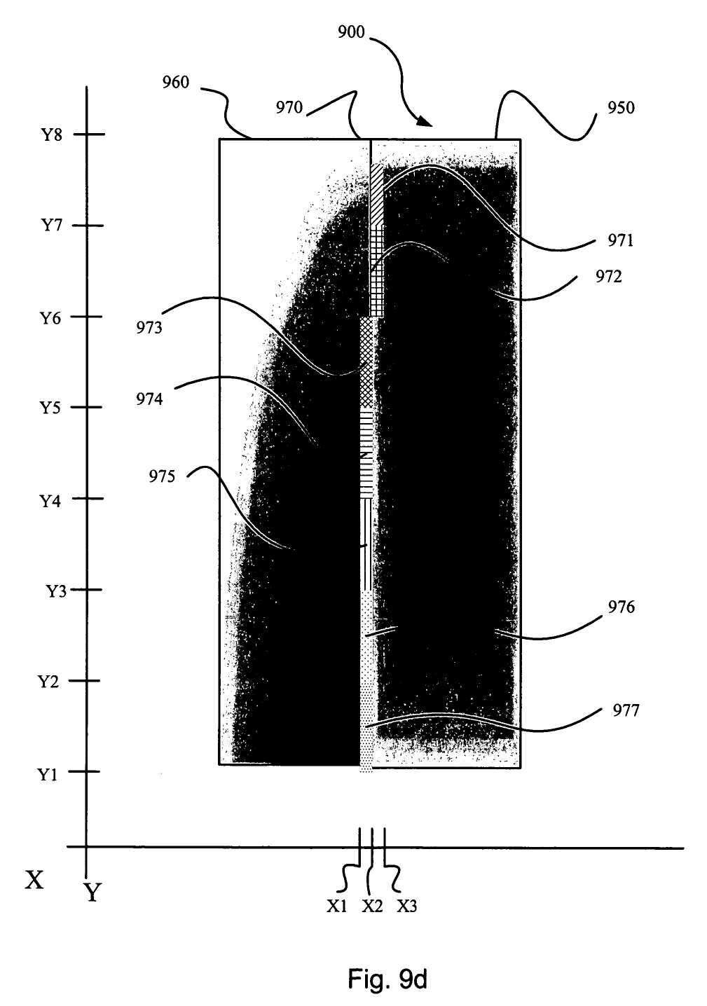

Turning to FIG. 9, a process in accordance with some embodiments for variable color trapping is shown as a series of steps. Turning to FIG. 9A, a media production 900 including an object 960 and an object 950 is shown. Both object 960 and object 950 are painted with a variable color. It should be noted at this juncture that while both objects are shown with variable color, it may be that one of the objects is painted with a constant color and the other with a variable color. Further, it should be noted at this juncture that while only two objects are involved, the described process may be used in relation to three or more objects where one or more of the objects is painted with a variable color. In some cases where three or more objects are involved in a particular trap, the recursive trapping principles discussed in relation to FIG. 6 above may be applied with modifications that account for the inclusion of one or more variable colors in the analysis. An X-axis 910 and a Y-axis 930 are included with the drawing for descriptive purposes. Also, for the purposes of this discussion, it is assumed that object 960 is a foreground object, and object 950 is a background object.

Turning to FIG. 9B, a trap zone 970 is defined at the intersection of object 960 and object 950. Three location markers X1, X2, X3 are included along X-axis 910 for discussion purposes. Location marker X2 indicates the location of the intersection boundary between object 950 and object 960. Location marker X1 indicates the extent to which trap zone 970 extends into object 960, and location marker X3 indicates the extent to which trap zone 970 extends into object 950.

Turning now to FIG. 9C, trap zone 970 is segmented resulting in a number of individual segments 971, 972, 973, 974, 975, 976, 977. The relative location of segments 971, 972, 973, 974, 975, 976, 977 are marked respectively along Y-axis 930 as Y1, Y2, Y3, Y4, Y5, Y6, Y7 and Y8. Upon reading this disclosure, one of ordinary skill in the art will appreciate that any number of segments may be employed in performing a variable trap. In general, a larger number of segments will result in a smoother transition between the objects, but will generally also require additional processing time to complete the trap. Based on the disclosure provided herein, one of ordinary skill in the art would be able to determine an appropriate number of segments to be defined.

In some embodiments, the segment size is determined to assure that colors on either side of the trap at the particular segment location are generally constant across the length of the segment. Thus, for example, segment 971 may be sized such that the region of object 960 abutting segment 971 exhibits a substantially constant color between positions Y7 and Y8, and that the region of object 950 abutting segment 971 also exhibits a substantially constant color between positions Y7 and Y8. In this way, a trap direction and color arbitration can be performed based on the substantially constant colors abutting segment 970. Thus, while each of segments 971, 972, 973, 974, 975, 976, 977 appear to be of equal length, it may be possible that one segment is longer than another. However, based on the disclosure provided herein, one of ordinary skill in the art will recognize that in some implementations it may be desirable to use segments of a single length.

Alternatively, rather than requiring that a substantially constant color abut a particular trap zone segment, it may be desirable to simply choose a sufficiently small segment size and use the abutting colors at the mid-point of the segment to perform trap direction and color arbitration analysis. As yet another alternative, it may be desirable to define an average color for the areas abutting a particular segment, and use these average colors to perform trap direction and color arbitration analysis. As yet another example, it may be desirable to fix the segment length to a pixel width and thereby assure constant color abutting either side of a given segment. Based on the disclosure provided herein, one of ordinary skill in the art will recognize a variety of approaches that may be used to establish the length of segments and/or location of segments within a given trap zone.

Turning to FIG. 9D, a trap direction and color arbitration may be performed for each of the individual segments 971, 972, 973, 974, 975, 976, 977. In the illustrated example, the trap direction for segment 971 and segment 972 are determined to be spreads (i.e., the trap zone extends from X2 to X3), and the trap direction for the other segments 973, 974, 975, 976, 977 are determined to be chokes (i.e., the trap zone extends from X1 to X2). Further, a color arbitration is performed between the colors abutting either side of the individual segments 971, 972, 973, 974, 975, 976, 977. This color arbitration results in a color selected for each of the individual segments 971, 972, 973, 974, 975, 976, 977. The selected colors are indicated by the following patterns painted in each of the individual segments: a right diagonal pattern in segment 971, a vertical and horizontal cross-hatched pattern in segment 972, a diagonal cross-hatched pattern in segment 973, a horizontal pattern in segment 974, a vertical pattern in segment 975, a far dotted pattern in segment 976, and a close dotted pattern in segment 977. As with the previous use of patterns, it should be noted that the pattern may represent any color resulting from any color selection process based on colors abutting the sides of a particular segment.

A transfer function may then be formed that describes trap zone 970 and corresponding to the individual segments 971, 972, 973, 974, 975, 976, 977. Thus, trap zone 970 of FIG. 9D may be reduced to the following transfer functions associated with the respective segments:
Segment 971: for (X>=X2 AND X<X3) {
   for (Y>=Y7 AND Y<Y8) {
      paint color selected for segment 971}}
Segment 972: for (X>=X2 AND X<X3) {
   for (Y>=Y6 AND Y<Y7){
      paint color selected for segment 972}}
Segment 973: for (X>X1 AND X<=X2){
   for (Y>=Y5 AND Y<Y6){
      paint color selected for segment 973}}
Segment 974: for (X>X1 AND X<=X2){
   for (Y>=Y4 AND Y<Y5){
      paint color selected for segment 974}}
Segment 975: for (X>X1 AND X<=X2){
   for (Y>=Y3 AND Y<Y4){
      paint color selected for segment 975}}
Segment 976: for (X>X1 AND X<=X2){
   for (Y>=Y2 AND Y<Y3){
      paint color selected for segment 976}}
Segment 977: for (X>X1 AND X<=X2) {
   for (Y>=Y1 AND Y<Y2){
      paint color selected for segment 977}}

Two or more of the preceding transfer functions may then be reduced to an overall transfer function describing all or part of trap zone 970. In such a case, the overall transfer function would be a step transfer function. As an example, the transfer function describing all of trap zone 970 would be:
Trap Zone 970: for (X>X1 AND X<=X2){
   for (Y>=Y1 AND Y<Y2){
      paint color selected for segment 977}
   for (Y>=Y2 AND Y<Y3){
      paint color selected for segment 976}
   for (Y>=Y3 AND Y<Y4) {
      paint color selected for segment 975}
   for (Y>=Y4 AND Y<Y5) {
      paint color selected for segment 974}
   for (Y>=Y5 AND Y<Y6) {
      paint color selected for segment 973}}
for (X>=X2 AND X<X3){
   for (Y>=Y6 AND Y<Y7){
      paint color selected for segment 972}
   for (Y>=Y7 AND Y<Y8) {
      paint color selected for segment 971}}

In other cases, a smooth transfer function can be established to describe trap zone 970. Thus, for example, where the aformentioned transfer functions associated with segments 971, 972, 973, 974, 975, 976, 977 provide for a smooth transition across step changes, a smooth or continuous transfer function may be possible. Such are often possible where one of the objects is a constant color and the other object is a variable color with the variable color capable of description using a smooth transfer function. Thus, for example, where we assume that object 950 is a constant color, and object 960 exhibits a progressive color change across the Y-axis, a smooth or continous function may be used to describe trap zone 970. As a more concrete example and assuming the same trap directions indicated in FIG. 9D, where the color of object 960 can be described as COLOR* 1.05Y, and the color is COLOR at location Y1, the following smooth or continuous transfer function may be used to describe trap zone 970 from X1 to X2 across Y1 to Y6:
Trap Zone 970: for (Y>=Y1 AND Y<Y2){
   (paint color selected for segment 977 as arbitrated with the opposing color at location Y1)*1.05Y}}
      Similarly, the following smooth or continuous transfer function may be used to describe trap zone 970 from X2 to X3 across Y6 to Y8:
Trap Zone 970: for (Y>=Y6 AND Y<Y8){
   (paint color selected for segment 977 as arbitrated with the opposing color at location Y1)*1.05Y}}
      Based on the disclosure provided herein, one of ordinary skill in the art will appreciate a myriad of transfer functions both step and continuous that may be used and/or derived in accordance with various embodiments of the present invention.

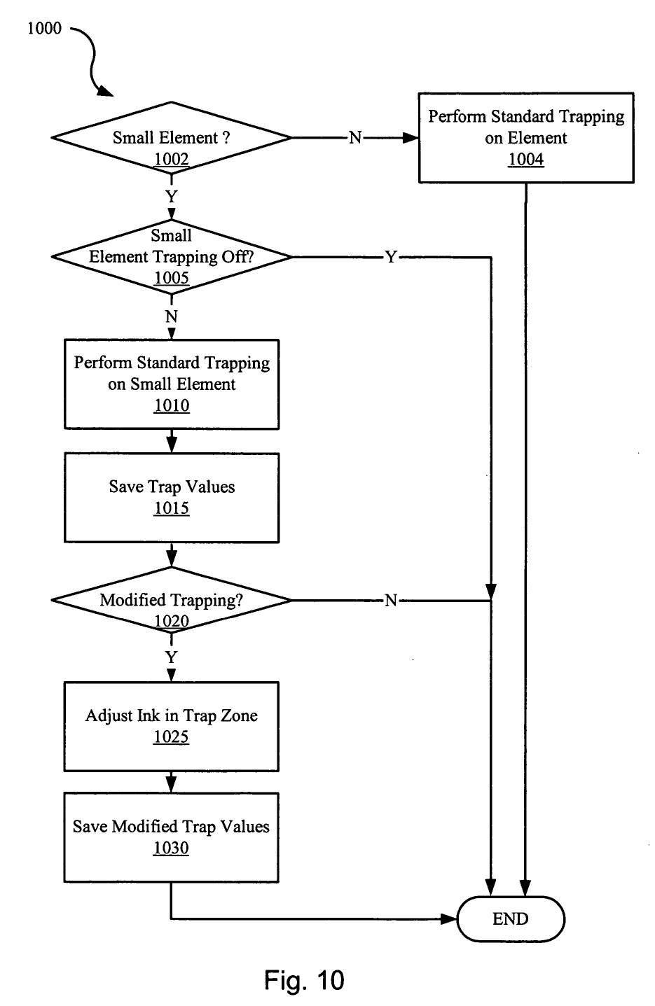

Turning now to FIG. 10, a flow diagram 1000 illustrates a method in accordance with some embodiments of the present invention for trapping in relation to small elements. Following flow diagram 1000, it is first determined whether if an object qualifies as a small element (block 1002). A small element may be defined in a number of ways. As just one of many examples, an object may be considered a small element where a trap zone associated with a dimension of the element is more than some defined percentage, such as, for example, twenty-five percent of a width of the dimension. Based on the disclosure provided herein, one of ordinary skill in the art will recognize a variety of characteristics that may be utilized to define an object as a “small element”. Where it is determined that an object does not qualify as a small element (block 1002), a trapping approach that is applied to other objects (i.e., a “default” or “standard” trapping approach) is applied to the object at issue (block 1004). This “standard” trapping approach may be, for example, one or another of the trapping approaches described in relation to preceding figures herein, or some other trapping approach.

Alternatively, where it is determined that the object qualifies as a small element (block 1002), it is determined if trapping is to be performed on small elements (block 1005). In some cases, a user selectable option may be provided that allows a user to turn off trapping for small elements. Where no trapping is to be performed (block 1005), the small element is instantiated without application of any trapping. Otherwise, where trapping is to be performed (block 1005), the standard trapping approach is applied to the small element (block 1010). Again, this “standard” trapping approach may be, for example, one or another of the trapping approaches described in relation to preceding figures herein, or some other trapping approach. The trap values resulting from application of the standard trapping approach are saved (block 1015).

It is then determined whether modified trapping is to be applied to the small object, or whether the standard trapping is acceptable (block 1020). Modified trapping is applied where the partial luminance of an ink displacing another ink in the trap zone has more than a threshold percentage of the total luminance of the small element. The threshold value may be user definable, but initiated to a default value. Thus, as just one example, where the color of the small element is comprised of Yellow and Cyan inks and the color of the background object is comprised of Magenta and Cyan ink, the trap zone will be painted with Cyan, Magenta and Yellow inks. The amount of Cyan ink will be determined through ink arbitration as discussed above. Where the amount of Cyan has a partial luminance which is greater than the threshold percentage of the total luminance of the color of the small element, modified trapping will be performed.

Where modified trapping is to be performed (block 1020), the ink(s) within the trap zone that were determined to have a partial luminance greater than the threshold are adjusted down such that the threshold limit is not exceeded (block 1025). This may result in a percentage reduction of one or more inks, and/or the elimination of one or more inks from the trap zone. These modified trap values are then stored (block 1030). Alternatively, where modified trapping is not to be performed (block 1020), the standard trapping values are retained for the small element.

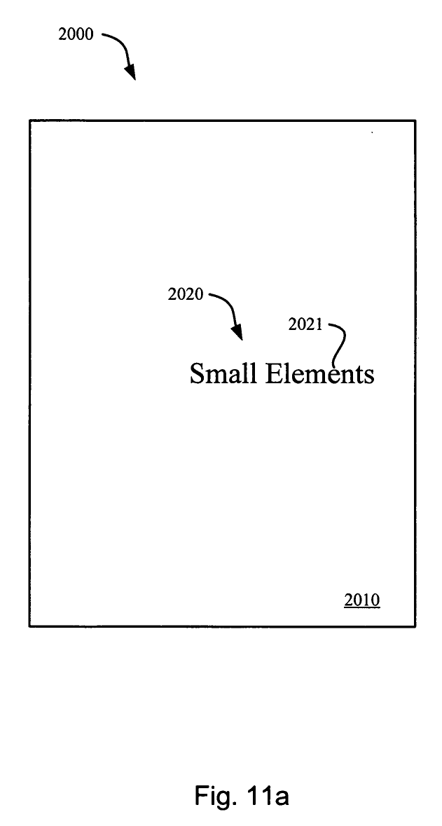

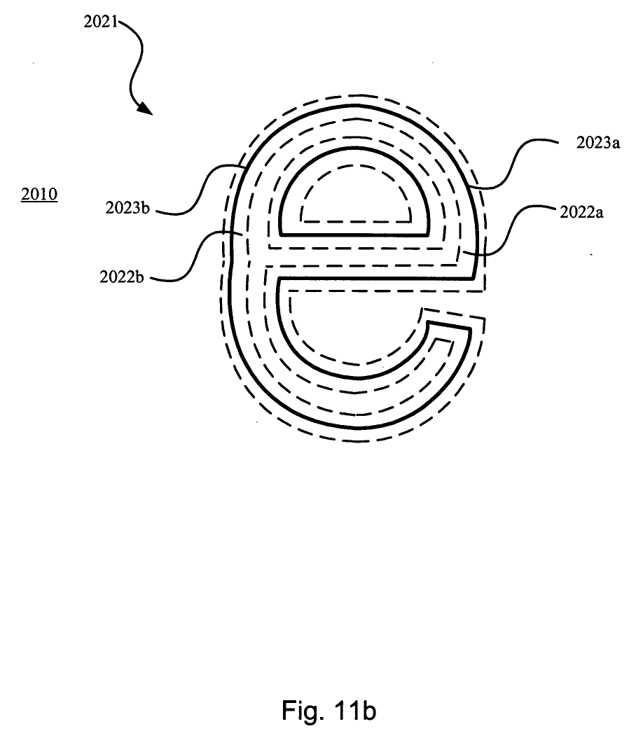

Turning to FIG. 11, one exemplary approach to small element trapping is discussed. In particular, FIG. 11a shows a group 2000 of two objects 2010, 2020 assembled into a design. Object 2020 includes multiple sub-objects including a text “e” object 2021. FIG. 11b shows a close up view of text “e” object 2021 in relation to object 2010. In addition, both a choke trap zone 2022 and a spread trap zone 2023 are shown in relation to small element 2021. Where we assume, for example, that based on small element 2021 and object 2010 that a spread is to occur, an ink arbitration is performed to determine the inks that will be applied in spread zone 2023. Then, because text “e” object 2021 is a small element, it is determined whether the inks to be formed in spread zone 2023 are to be modified. Where a modification is called for, it is done as discussed in relation to FIG. 10 above. It should be noted that a small element may be any element less than some dimension in size. Further, it should be noted that the preceding example coule have been equally described in relation to choke region 2022 where the ink arbitration associated with the trap is performed in relation to that region.

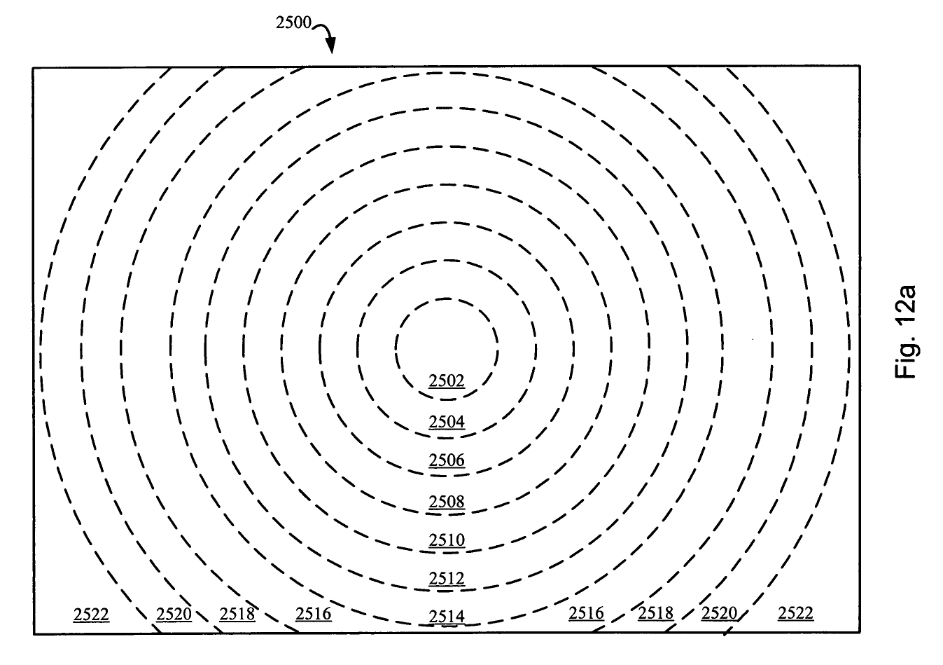

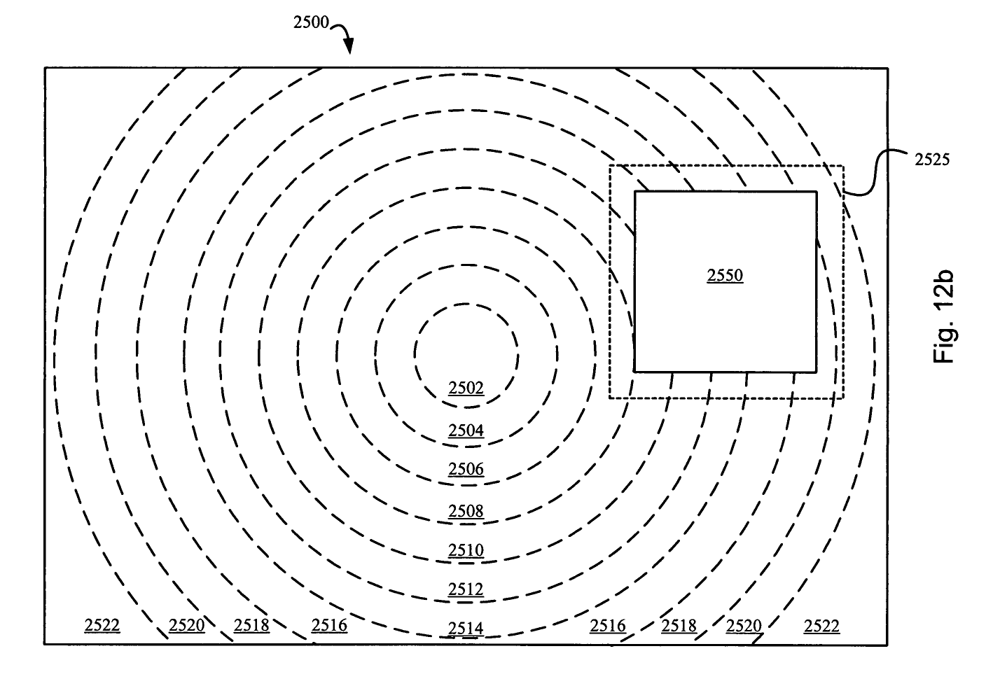

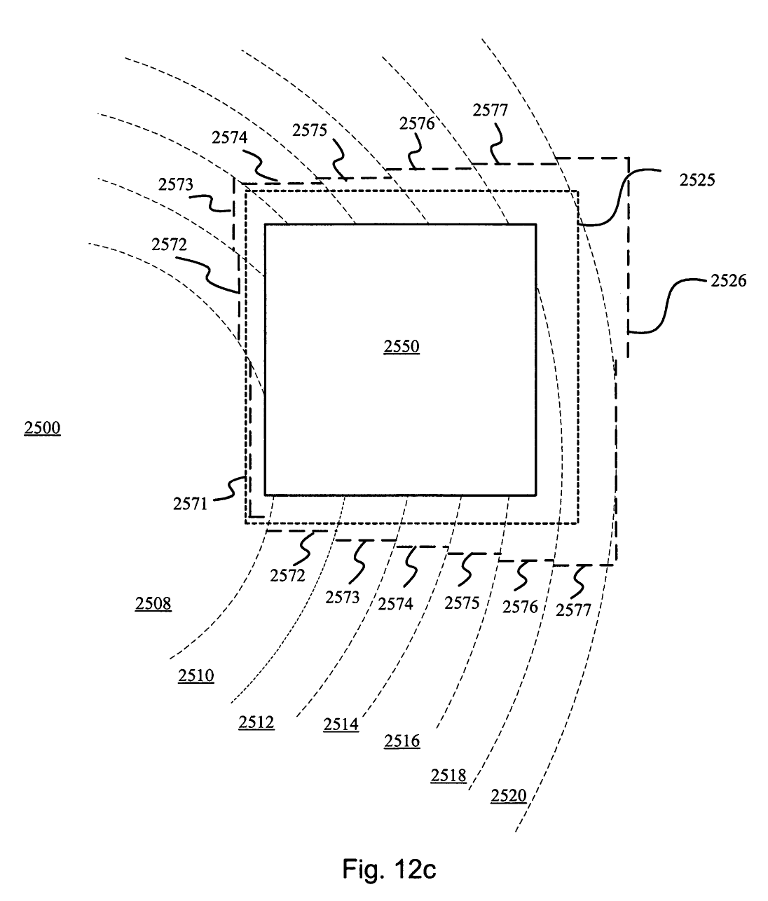

Turning now to FIG. 12, an example of location dependent trapping in accordance with one or more embodiments of the present invention is provided. Such location dependent trapping may be used where there is misregistration variance across the surface of a publication. For example, misregistration may be greatest at the center of a publication, and decreasingly reduced as you move radially outward from the center of the publication. Such a situation is shown in FIG. 12a where a number of dashed lines segment publication in 2500 into a number of regions 2502-2522 each with a defined, expected misregistration. The radial pattern roughly approximates the aforementioned decreasing misregistration as the location at issue moves farther from the center of publication 2500. At this juncture, it should be pointed out that patterns other than the radial pattern are possible depending upon a predicted misregistration associated with a publication. Also, it should be pointed out that the radial lines provide a step function that approximates what may be a smooth function for the misregistration. Thus, the granularity of the step function may be increased or decreased by modifying the number of segmented regions used to model the misregistration.

Turning to FIG. 12b, an object 2550 is placed on publication 2500 at the depicted location. Object 2550 includes a trap zone 2525 set forth by a dotted line. For simplicity, only a spread trap zone is shown and the example proceeds forth under an assumption that a spread is called for by one or more of the techniques set forth herein. However, one of ordinary skill in the art will understand that a choke trap zone may also be used with the same principles being applied. In this case, trap zone 2525 extends across a number of regions including regions 2508, 2510, 2512, 2514, 2516, 2518, 2520 and 2522. In each of these regions, trap zone 2525 may be adjusted to account for an increase or decrease in misregistration at that location. In a simple case, trap zone 2525 may be multiplied by unity at center region 2502, and multiplied by an incresing factor as you move across regions progressively farther from center region 2502. FIG. 12c shows such a situation with original trap zone 2525 shown as a dashed line, and a modified trap zone shown as a dashed line 2526. Modified trap zone 2526 includes a number of regions 2571-2578 each corresponding to respective regions 2508-2522.

In conclusion, the present invention provides novel systems, methods and arrangements for exchanging data. While detailed descriptions of one or more embodiments of the invention have been given above, various alternatives, modifications, and equivalents will be apparent to those skilled in the art without varying from the spirit of the invention. For example, trapping may be performed recursively or otherwise at the intersection of two or more objects, trapping may be performed on curvilinear boundaries, and/o trapping may be performed between objects of any color, size or shape. Therefore, the above description should not be taken as limiting the scope of the invention, which is defined by the appended claims.

What is claimed is:

1. A method for performing trapping where a variable color object is involved, the method comprising:
identifying a first object, wherein the first object is associated with a first color;
identifying a second object, wherein the second object is associated with a second color, and wherein the second color is a variable color;
defining a trap zone in relation to the first object and the second object; and
forming a transfer function, wherein the transfer function determines a trap attribute for a portion of the trap zone.

2. The method of claim 1, wherein the first color is a constant color.

3. The method of claim 1, wherein the first color is a variable color.

4. The method of claim 1, wherein the trap attribute is selected from a group consisting of: a trap direction and an ink in the trap zone.

5. The method of claim 4, wherein the trap direction is selected from a group consisting of: a choke and a spread.

6. The method of claim 1, wherein the method further comprises:
segmenting the trap zone into a plurality of portions, wherein the portion of the trap zone associated with the transfer function is one of the plurality of portions, and wherein the portion of the trap zone associated with the transfer function includes a substantially constant color region within the variable color of the second object.

7. The method of claim 1, wherein the transfer function is a first transfer function, wherein the portion of the trap zone is a first portion, wherein the trap attribute is a first trap attribute, and wherein the method further comprises:
segmenting the trap zone, wherein the trap zone is segmented into at least the first portion and a second portion; and
forming a second transfer function, wherein the second transfer function determines a second trap attribute for the second portion of the trap zone.

8. The method of claim 7, wherein the method further comprises:
aggregating the first transfer function and the second transfer function to form an overall transfer function.

9. The method of claim 8, wherein the overall transfer function is selected from a group consisting of: a step function and a continuous function.

10. A system for performing trapping in a variable color environment, the system comprising:
a computer associated with a computer readable medium, wherein the computer readable medium includes instructions executable by the computer to:
receive an indication of a trap zone, wherein the trap zone is associated with a first object and a second object, wherein the first object is associated with a first color, and wherein the second object is associated with a second color, and wherein the second color is a variable color;
form a transfer function, wherein the transfer function determines a trap attribute for a portion of the trap zone.

11. The system of claim 10, wherein the computer readable medium further includes instructions executable by the computer to:
identify the first object and the first color; and
identify the second object and the second color.

12. The system of claim 10, wherein the computer readable medium further includes instructions executable by the computer to:
segment the trap zone into a plurality of portions, wherein the portion of the trap zone associated with the transfer function is one of the plurality of portions, and wherein the portion of the trap zone associated with the transfer function includes a substantially constant color region within the variable color of the second object.

13. The system of claim 10, wherein the transfer function is a first transfer function, wherein the portion of the trap zone is a first portion, wherein the trap attribute is a first trap attribute, and wherein the computer readable medium further comprises instructions executable by the computer to:
segment the trap zone, wherein the trap zone is segmented into at least the first portion and a second portion; and
form a second transfer function, wherein the second transfer function determines a second trap attribute for the second portion of the trap zone.

14. The system of claim 13, wherein the first trap attribute is selected from a group consisting of: a trap direction and an ink in the trap zone.

15. The system of claim 14, wherein the second trap attribute is selected from a group consisting of: a trap direction and an ink in the trap zone.

16. The system of claim 15, wherein the trap direction is selected from a group consisting of: a choke and a spread.

17. The system of claim 15, wherein the first trap attribute is different from the second trap attribute.

18. The system of claim 13, wherein the computer readable medium further includes instructions executable by the computer to:
aggregate the first transfer function and the second transfer function to form an overall transfer function.

19. A computer readable medium, wherein the computer readable medium includes instructions executable by a computer to:
identify a first object, wherein the first object is associated with a first color;
identify a second object, wherein the second object is associated with a second color, and wherein the second color is a variable color;
define a trap zone in relation to the first object and the second object, wherein the trap zone includes a plurality of trap zone portions;
form a first transfer function, wherein the first transfer function determines a first trap attribute for a first portion of the trap zone; and
form a second transfer function, wherein the second transfer function determines a second trap attribute for a second portion of the trap zone.

20. The computer readable medium of claim 19, wherein the first trap attribute is different from the second trap attribute.
